(19) United States
(12) Patent Application Publication
(10) Pub. No.: US 2026/0290780 A1
(43) Pub. Date: Sep. 24, 2026

(54) METHOD FOR PRODUCING ELECTRODE, APPARATUS FOR PRODUCING ELECTRODE, AND LIQUID COMPOSITION

(71) Applicants: Kayato OHYA, Kanagawa (JP); Toshiya SHIRAKURA, Kanagawa (JP); Aya UTSUKI, Tokyo (JP); Masako ICHINOSE, Kanagawa (JP); Ryuji HIGASHI, Kanagawa (JP); Tomomasa KAJITA, Kanagawa (JP)

(72) Inventors: Kayato OHYA, Kanagawa (JP); Toshiya SHIRAKURA, Kanagawa (JP); Aya UTSUKI, Tokyo (JP); Masako ICHINOSE, Kanagawa (JP); Ryuji HIGASHI, Kanagawa (JP); Tomomasa KAJITA, Kanagawa (JP)

(73) Assignee: Ricoh Company, Ltd., Tokyo (JP)

(21) Appl. No.: 19/566,144

(22) Filed: Mar. 13, 2026

(30) Foreign Application Priority Data
Mar. 21, 2025 (JP) 2025-047575

(51) Int. Cl. H01M 4/04

(52) U.S. Cl. CPC H01M 4/0404; H01M 4/0419

(57) ABSTRACT

A method for producing an electrode includes: applying a liquid composition including an active material and a dispersion medium onto a predetermined region of a substrate and a region adjacent to the predetermined region with directivity. During the applying, a difference from a time when the liquid composition is applied onto the predetermined region to a time when the liquid composition is applied onto the adjacent region is determined as δt. A viscosity η₁₀₀₀ of the liquid composition at a shear rate of 1,000 s⁻¹ is 200 mPa·sec or less, and a viscosity η_{0.1} of the liquid composition at a shear rate of 0.1 s⁻¹ is 1,000 mPa·sec or greater. When a shear force is applied at a shear rate of 1,000 s⁻¹ for 50 seconds, followed by changing to 0.1 s⁻¹, a viscosity at δt after changing the shear rate to 0.1 s⁻¹ is 300 mPa·sec or less.

### CROSS-REFERENCE TO RELATED APPLICATIONS

The present application is based on and claims priority under 35 U.S.C. § 119 to Japanese Patent Application No. 2025-047575, filed on Mar. 21, 2025, the contents of which are incorporated herein by reference in their entireties.

### BACKGROUND OF THE INVENTION

### 1. Field of the Invention

The present disclosure relates to methods for producing electrodes, apparatuses for producing electrodes, and liquid compositions.

### 2. Description of the Related Art

In recent years, applications of electrochemical elements, such as lithium-ion secondary battery cells, electric double layer capacitors, lithium-ion capacitors, and redox capacitors, have been rapidly expanding from small consumer devices, such as wearable devices and smartphones, to large devices, such as electric vehicles and stationary storage batteries.

In response to such diversified needs for electrochemical elements, an electrode production method by intermittent coating has been attracting attention in recent years from viewpoints of green transformation, cost reduction due to reduction in material loss, and the like.

A contact coating system, such as a die coater, which is generally used for an electrode production method, realizes intermittent coating of a liquid composition on a substrate by vertically moving the die with respect to the substrate. However, there is a problem of “ridges” which refer to a state where a film thickness of the liquid composition becomes large at a starting edge and a finishing edge of the coating and therefore uniformity in film thickness cannot be obtained.

To solve such a problem, various electrode production methods have been proposed for obtaining an electrode having excellent uniformity in film thickness from the viewpoint of improvement in intermittent battery characteristics. For example, there is proposed a production method in which a flat upper mold and a flat lower mold that define a gap of a discharge flow path structure are provided (see, for example, WO2010/082230).

### SUMMARY OF THE INVENTION

According to one aspect of the present disclosure, a method for producing an electrode includes includes applying a liquid composition, which includes an active material and a dispersion medium, onto a predetermined region of a substrate and onto a region adjacent to the predetermined region with directivity. During the applying, a time difference from a time when the liquid composition is applied onto the predetermined region to a time when the liquid composition is applied to the region adjacent to the predetermined region is determined as δt, a viscosity η₁₀₀₀ of the liquid composition at a shear rate of 1,000 s⁻¹ is 200 mPa·sec or less, and a viscosity η_{0.1} of the liquid composition at a shear rate of 0.1 s⁻¹ is 1,000 mPa·sec or greater, and when a shear force is applied to the liquid composition at a shear rate of 1,000 s⁻¹ for 50 seconds, followed by changing the shear rate to a shear rate of 0.1 s⁻¹, a viscosity of the liquid composition at δt seconds after changing the shear rate to 0.1 s⁻¹ is 300 mPa·sec or less.

### BRIEF DESCRIPTION OF THE DRAWINGS

FIG. 1 is a schematic view illustrating an example of an electrode produced by the method for producing the electrode according to one embodiment of the present disclosure;

FIG. 2 is a schematic view illustrating an effect of thixotropy of the liquid composition on uniformity in film thickness at an application time difference δt in the method for producing the electrode according to one embodiment of the present disclosure;

FIG. 3 is a schematic view illustrating an example of a configuration of an apparatus for producing an electrode, in which one nozzle hole is provided, in the method for producing the electrode according to one embodiment of the present disclosure;

FIG. 4 is a schematic view illustrating the apparatus for producing the electrode according to one embodiment of the present disclosure;

FIGS. 5A to 5D are schematic views illustrating a configuration in which a plurality of nozzle holes are provided in the method for producing the electrode according to one embodiment of the present disclosure;

FIG. 6 is a schematic view illustrating the apparatus for producing the electrode according to one embodiment of the present disclosure;

FIGS. 7A to 7C are schematic views illustrating examples of the apparatus for producing the electrode according to one embodiment of the present disclosure;

FIG. 8 is a schematic cross-sectional view illustrating an example of an electrode obtained by the method for producing the electrode according to one embodiment of the present disclosure;

FIG. 9 is a schematic cross-sectional view illustrating the electrode obtained by the method for producing the electrode according to another embodiment of the present disclosure;

FIG. 10 is a schematic view illustrating the apparatus for producing the electrode according to one embodiment of the present disclosure;

FIG. 11 is a schematic view illustrating the apparatus for producing the electrode according to another embodiment of the present disclosure;

FIG. 12 is a schematic view illustrating the apparatus for producing the electrode according to yet another embodiment of the present disclosure;

FIG. 13 is a schematic view illustrating a modification example of the apparatus for producing the electrode according to one embodiment of the present disclosure;

FIG. 14 is a configuration diagram illustrating one example of a printer employing an inkjet system and a transfer system as a liquid composition applicator in the apparatus for producing the electrode according to one embodiment of the present disclosure (part 1);

FIG. 15 is a configuration diagram illustrating another example of the printer employing the inkjet system and the transfer system as the liquid composition applicator in the apparatus for producing the electrode according to one embodiment of the present disclosure (part 2);

FIG. 16 is a schematic cross-sectional view illustrating an electrochemical element according to one embodiment of the present disclosure;

FIG. 17 is a schematic cross-sectional view illustrating the electrochemical element according to another embodiment of the present disclosure;

FIG. 18 is a schematic view illustrating a vehicle serving as the electrochemical element according to one embodiment of the present disclosure;

FIG. 19 is a schematic view illustrating a nozzle pattern in Production Example 1;

FIG. 20 is a schematic view illustrating a nozzle pattern in Production Example 2;

FIG. 21 is a schematic view illustrating a nozzle pattern in Production Example 3; and

FIG. 22 is a schematic view illustrating a nozzle pattern in Production Example 4.

### DESCRIPTION OF THE EMBODIMENTS

One aspect of the present disclosure aims to provide a method for producing an electrode, which can achieve high productivity and excellent uniformity in film thickness.

The method for producing the electrode according to one embodiment of the present disclosure is a method that includes applying a liquid composition, which includes an active material and a dispersion medium, onto a predetermined region of a substrate and onto a region adjacent to the predetermined region with directivity. During the applying, a time difference from a time when the liquid composition is applied onto the predetermined region to a time when the liquid composition is applied to the adjacent region is determined as δt, a viscosity η₁₀₀₀ of the liquid composition at a shear rate of 1,000 s⁻¹ is 200 mPa·sec or less, and a viscosity η_{0.1} of the liquid composition at a shear rate of 0.1 s⁻¹ is 1,000 mPa·sec or greater, and when a shear force is applied to the liquid composition at a shear rate of 1,000 s⁻¹ for 50 seconds, followed by changing the shear rate to a shear rate of 0.1 s⁻¹, a viscosity of the liquid composition at δt seconds after changing the shear rate to 0.1 s⁻¹ is 300 mPa·sec or less.

According to the method for producing the electrode of one embodiment of the present disclosure, an electrode having excellent uniformity in film thickness can be produced with high productivity.

According to an existing method (e.g., the method disclosed in WO2010/082230), a die is preferably precisely controlled to inhibit formation of ridges. Therefore, a transporting speed of a substrate cannot be increased. In the case where a coating width is increased, moreover, controllability of edges decreases. Therefore, it is difficult to improve productivity in such a method. As a method for achieving both inhibition of ridges and improved productivity, a non-contact application method is regarded as being effective considering a mechanism for forming ridges.

As the non-contact application method, for example, there is jet dispensing. For example, with reference to Advanced Energy Materials, 6 (18): 1600856, 2016, and Sustainable Materials and Technologies 25 e00190, 2020, an applied liquid composition is immediately thickened. Therefore, a resultant electrode has surface roughness, and an electrode having excellent uniformity in film thickness cannot be obtained.

Examples of the non-contact application method include inkjet printing, jet dispensing, spraying, and the like.

The inkjet printing using a Newtonian fluid is generally effective as a method for forming a thin film of approximately several micrometers, but is not suitable for forming a thick film.

The jet dispensing that generally uses a non-Newtonian fluid (a pseudoplastic fluid) is often used for pattern drawing with a single stroke, and is also not suitable for forming a coating film having high uniformity in film thickness. For example, it is disclosed in Advanced Energy Materials, 6 (18): 1600856, 2016, and Sustainable Materials and Technologies 25 e00190, 2020, that jet dispensing is used to intentionally impart roughness to a surface of a coating film.

It has been generally known that uniformity in film thickness is improved in spraying by adjusting a viscosity recovery rate of a liquid composition that is a non-Newtonian fluid (a pseudoplastic fluid) (see, for example, Japanese Patent No. 7029998). However, the liquid composition is applied from a discharge hole to a substrate without directivity due to characteristics of spraying, and therefore spraying is not suitable for intermittent printing without a mask.

The viscosity recovery rate is also a general concept in a contact application method, such as brush coating and screen printing, but it is difficult to achieve both inhibition of ridges and improved productivity according to the above contact method, as in die coating using a die coater.

As described above, a further improvement is desired to achieve both uniformity in film thickness and productivity in intermittent coating of an electrode according to existing contact application methods and non-contact application methods.

The details of the present disclosure will be described hereinafter.

### (Method for Producing Electrode)

### (Method and Apparatus for Producing Electrode)

The method for producing the electrode according to the present embodiment includes an application step, and may further include other steps, as necessary.

### <Application Step and Applicator>

The application step is a step that includes applying a liquid composition, which includes an active material and a dispersion medium, onto a predetermined region of a substrate and onto a region adjacent to the predetermined region with directivity.

The applicator is a device configured to apply a liquid composition, which includes an active material and a dispersion medium, onto a predetermined region of a substrate and onto a region adjacent to the predetermined region with directivity.

In the present specification, the term “with directivity” means that the liquid composition is applied from the apparatus for producing the electrode to the substrate by causing the liquid composition to jet in a specific direction. Examples of such an application method include non-contact application methods, such as inkjet printing, jet dispensing, and the like. In contrast, spraying in which the liquid composition is uniformly applied over a surface is clearly distinguished from the above non-contact application method with directivity.

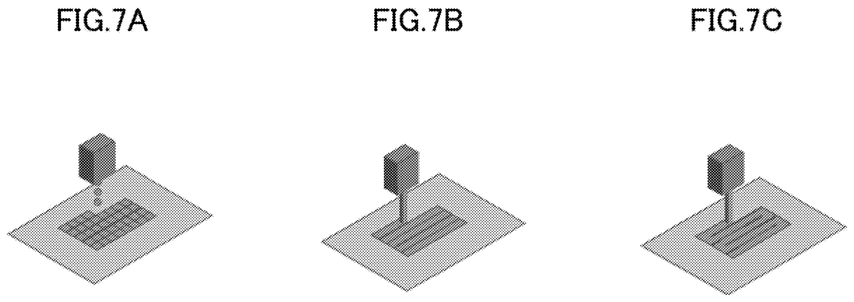

In the application step, the liquid composition may be continuously or discontinuously applied onto the substrate. FIGS. 7A to 7C are schematic perspective views illustrating the method for continuously or discontinuously applying the liquid composition onto the substrate.

FIG. 7A illustrates the method for discontinuously applying the liquid composition onto the substrate. Examples of the method for discontinuously applying the liquid composition include inkjet printing and the like. The term “discontinuously” means that the liquid composition is applied from the applicator onto the substrate several times. Specifically, the discontinuous application means that the liquid composition is subsequently applied in a position at which the applied liquid composition can be joined with the liquid composition that has been applied earlier. Specifically, when there are a plurality of portions of the active material layer formed by intermittent coating, such an application of the liquid composition is not defined as discontinuous application in the present disclosure because the plurality of the portions are not joined together. Conversely, a case where one active layer is formed by intermittent coating is defined as discontinuous application, if the liquid composition is applied several times to form the one active material layer.

FIGS. 7B and 7C illustrate the method for continuously applying the liquid composition onto the substrate. Examples of the method for continuously applying the liquid composition include bubble-head inkjet printing, jet dispensing, and the like. In the case where the liquid composition is continuously applied by the applicator, for example, the liquid composition is applied into a line, and the line of the applied liquid composition is adjacent to another line of the liquid composition as illustrated in FIGS. 7B and 7C. FIG. 7B illustrates the method for discontinuously discharging the liquid composition when the applicator is turned back. FIG. 7C illustrates the method for continuously discharging the liquid composition when the applicator is turned back.

The application time difference δt is a difference from the time when Liquid Composition A is applied to the time when Liquid Composition B is applied, when there are the liquid composition (for example, referred to as “Liquid Composition A” hereinafter) that has been applied onto the substrate, and the liquid composition (for example, referred to as “Liquid Composition B” hereinafter) that has been subsequently applied in a position at which the subsequently applied liquid composition can be joined with the liquid composition applied earlier (Liquid Composition A). In the case where the liquid composition is applied several times at the position at which the subsequently applied liquid composition is joined with the liquid composition applied earlier, the time difference with respect to the liquid composition that has been applied immediately before is defined as δt.

<<Viscosity η(δt) of Liquid Composition at Application Time Difference δt>>

In the below-described thixotropy evaluation, the viscosity η(δt) of the liquid composition at the application time difference δt is 300 mPa·sec or less. When the viscosity η(δt) is 300 mPa·sec or less, the effects of the present disclosure can be obtained. The reason why the effects of the present disclosure are obtained in the above viscosity range is not clear, but is considered to be as follows.

Since the liquid composition is a pseudoplastic fluid that has a high viscosity at a low shear rate, a shear force is applied to the liquid composition at a high shear rate and the viscosity of the liquid composition becomes low when the liquid composition is discharged from the apparatus for producing the electrode. Once the liquid composition lands on the substrate, the shear force is not applied to the liquid composition, and therefore the liquid composition thickens with time. Specifically, droplets of the liquid composition that have landed earlier gradually thicken with time and lose the leveling properties. Next, Liquid Composition B is applied at the position adjacent to Liquid Composition A at the application time difference δt to join with Liquid Composition A. During the above process of the application of Liquid Composition B, Liquid Composition B has a low viscosity and excellent leveling properties, whereas Liquid Composition A is already thickened and has lost leveling properties. Therefore, the droplet of Liquid Composition B is leveled to be pulled by Liquid Composition A, and therefore the droplet of Liquid Composition B on the substrate has an asymmetric shape. It is considered that the uniformity in film thickness is impaired by repeating the above process.

The thixotropy evaluation simulates the behavior of the viscosity change of the liquid composition over time after landing (for example, see Table 2). The viscosity η(δt) being 300 mPa·sec or less in the thixotropy evaluation simulates a case where a subsequently applied liquid composition lands in a state in which a liquid composition that has landed earlier still has favorable fluidity. Since both liquid composition portions have fluidity, a uniformity in film thickness is secured.

From the viewpoint of small surface roughness Ra, the viscosity η(δt) is preferably 200 mPa·sec or less, and particularly preferably 150 mPa·sec or less. From the viewpoint of inhibition of flowing due to surface tension after coalescence or the influence of external forces, the viscosity η(δt) is preferably 20 mPa·sec or greater, and particularly preferably 50 mPa·sec or greater.

The application time difference δt is not particularly limited, as long as the above viscosity can be satisfied. From the viewpoint of a shorter taper length, the application time difference δt is preferably 10 seconds or shorter, more preferably 5 seconds or shorter, and particularly preferably 1 second or shorter.

The applicator is a device configured to apply the liquid composition onto the substrate with directivity. The applicator includes one or more nozzle holes for discharging the liquid composition. The nozzle hole or the substrate, or both the nozzle hole and the substrate, have a mechanism capable of being transported in one or more axial directions.

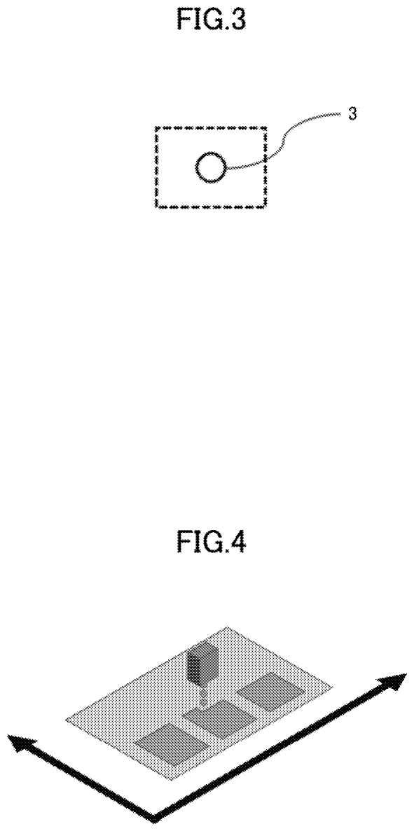

In the case where a single nozzle hole 3 is provided as illustrated in FIG. 3, the nozzle hole or the substrate, or both the nozzle hole and the substrate, may have a mechanism capable of being transported in two or more directions (for example, the directions indicated by the arrows in FIG. 4) that are not parallel to each other, as illustrated in FIG. 4.

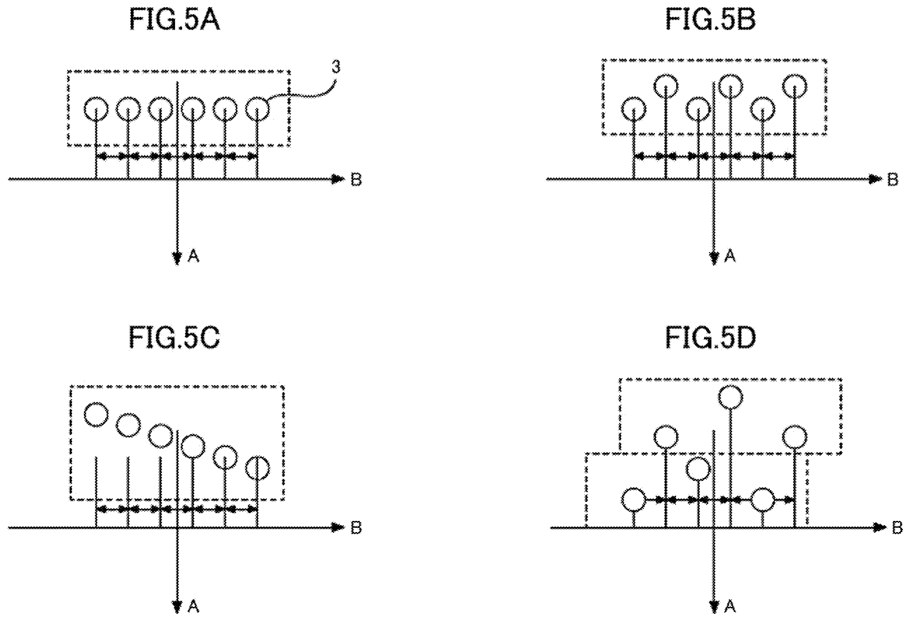

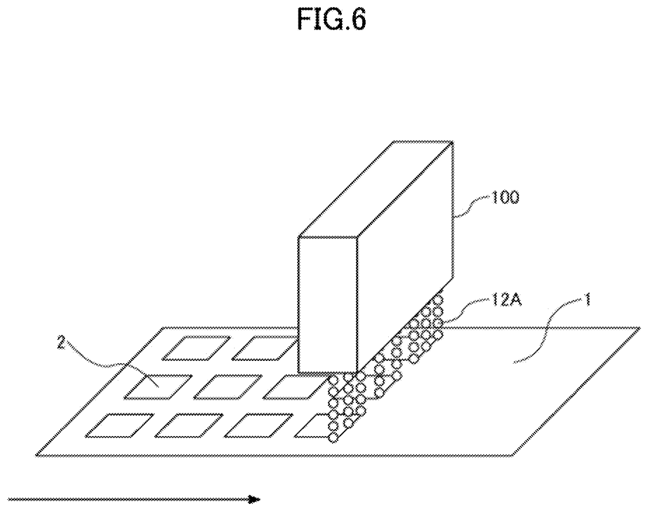

In the case where multiple nozzle holes 3 are provided as illustrated in FIGS. 5A to 5D and an applicable width is equal to or greater than a coating width, the nozzle holes or the substrate, or both the nozzles hole and the substrate, may have a mechanism capable of being transported in one or more axial directions (for example, the direction indicated by the arrow in FIG. 6), as illustrated in FIG. 6.

In the case where there are multiple nozzle holes 3, the apparatus for producing the electrode preferably includes a discharge head, in which the multiple nozzle holes are disposed at even intervals, as viewed in a projected image of the nozzle holes 3 along a virtual axis in the direction B perpendicular to the transporting direction A of the substrate, as illustrated in FIGS. 5A to 5D. The apparatus for producing the electrode may include a plurality of discharge heads. FIGS. 5A to 5D are schematic views illustrating a nozzle surface of a discharge head.

The multiple nozzle holes are preferably disposed because the application time difference δt can be shortened. Since the application time difference δt for the entire electrode surface can be shortened, the nozzle holes are preferably aligned symmetrically in the direction B perpendicular to the transporting direction A of the substrate. For example, the configuration illustrated in FIGS. 5B and 5D are preferable.

The apparatus for producing the electrode may further include other members, as necessary.

The applicator is not particularly limited, and may be appropriately selected according to the intended purpose. Examples of the applicator include a jet dispenser, an inkjet applicator, and the like. From the viewpoint of a short application time difference δt, an inkjet applicator, in which a plurality of nozzle holes can be aligned into arrays with a high spatial resolution, is particularly preferable.

Examples of a discharge head used in the inkjet applicator include a piezoelectric inkjet head, a thermal inkjet head, a bubble jet head, and the like. Among the above discharge heads, a bubble jet head is preferable from the viewpoint of a large nozzle hole size and excellent dischargeability of a positive or negative electrode active material with a relatively large particle size, a liquid composition having a high solid content, and a highly viscous liquid composition of a non-spherical composition, such as carbon nanotubes or carbon nanofibers.

A shape of the nozzle hole is not particularly limited, but is particularly preferably a circular shape from the viewpoint of improvement in directivity. A nozzle size is not particularly limited, and may be appropriately selected according to the intended purpose. From the viewpoint of excellent image formation without liquid dripping from the nozzle, the nozzle size is preferably 70 μm or greater. From the viewpoint of inhibition of nozzle clogging with a single particle or aggregates of the positive or negative electrode active material and excellent discharge stability, the nozzle size is preferably 100 μm or greater, and more preferably 150 μm or greater.

A discharge pattern refers to a manner in which the liquid composition is discharged from one or more nozzle holes. The discharge pattern is roughly classified into a pattern in which droplets of the liquid composition are discharged discontinuously as illustrated in FIG. 7A, and a pattern in which the liquid composition is discharged in the form of liquid columns by continuously applying an external force as illustrated in FIG. 7B. The discharge pattern is not particularly limited, as long as the effects of the present disclosure can be obtained. The discharge pattern from one nozzle hole is preferably continuous because the application time difference δt is shortened.

An interval at which the liquid composition is discontinuously applied onto the substrate is not particularly limited, as long as the effects of the present disclosure can be obtained. From the viewpoint of easiness of joining of the applied liquid composition portions, the interval is preferably 2.5 mm or less, more preferably 1.3 mm or less, and particularly preferably 0.85 mm or less.

### <Substrate>

The substrate is not particularly limited, and may be appropriately selected according to the intended purpose, as long as the substrate has electron conductivity and is stable to the applied potential. Examples of the substrate include aluminum foils, copper foils, stainless steel foils, titanium foils, etched foils obtained by etching any of the forgoing foils to form fine holes, carbon coated foils in each of which a surface layer is coated with a carbon-containing resin layer, foils coated with a phase-transfer catalyst (PTC) layer, perforated substrates used for lithium ion capacitors, and the like.

In the present specification, the substrate used for a negative electrode may be referred to as a “negative electrode substrate” or a “substrate for a negative electrode”, and the substrate used for a positive electrode may be referred to as a “positive electrode substrate” or a “substrate for a positive electrode”.

### <Liquid Composition>

The liquid composition for use in the present disclosure has the following characteristics in a thixotropy evaluation. When a load is applied to the liquid composition at a shear rate of 0.1 s⁻¹ for 300 seconds, and then the shear rate is increased to 1,000 s⁻¹ and is maintained at the shear rate of 1,000 s⁻¹ for 50 seconds, followed by reducing the shear rate to 0.1 s⁻¹, the viscosity of the liquid composition at δt seconds from the reduction of the shear rate to 0.1 s⁻¹ is 300 mPa·sec or less. In addition, the viscosity η₁₀₀₀ of the liquid composition at the shear rate of 1,000 s⁻¹ after applying a load at the shear rate of 1,000 s⁻¹ for 300 seconds is 200 mPa·sec or less. The viscosity η_{0.1} of the liquid composition at the shear rate of 0.1 s⁻¹ when the shear rate is increased to 0.1 s⁻¹ and is maintained for 50 seconds is 1,000 mPa·sec or greater.

When the viscosity η₁₀₀₀ of the liquid composition is 200 mPa·sec or less, an electrode having excellent uniformity in film thickness can be obtained. The viscosity η(δt) of the liquid composition is preferably 150 mPa·sec or less, and particularly preferably 100 mPa·sec or less from the viewpoint of further reduction in surface roughness Ra. In addition, the viscosity (δt) of the liquid composition is preferably 20 mPa·sec or greater, and particularly preferably 50 mPa·sec or greater because it is less likely to receive an influence of an external force when the liquid composition is discharged from the apparatus for producing the electrode to the substrate.

When the viscosity η_{0.1} is 1,000 mPa·sec or greater, an electrode having excellent uniformity in film thickness is obtained. The viscosity η_{0.1} is preferably 5,000 mPa·sec or greater, and particularly preferably 10,000 mPa·sec or greater because the liquid composition is less likely to be affected by external factors, such as vibrations during a transporting step serving as other steps, in which the substrate on which the liquid composition has been applied is transported to a drying furnace, or a convective heat transfer in a drying step, and because uniformity in film thickness is further improved.

A method for measuring the rheology of the liquid composition of the present disclosure is not particularly limited, and may be appropriately selected according to the intended purpose. A device used for the measurement is not particularly limited, and may be appropriately selected according to the intended purpose. Examples of the method include a method in which measurement is performed by a rheometer (MCR302e, manufactured by Anton Paar GmbH) using a cone plate (CP-50, manufactured by Anton Paar GmbH).

The rheology of the liquid composition is evaluated at a temperature of the liquid composition in the application step of the present disclosure. In the present specification, the application step and the rheology evaluation are assumed to be performed in an environment at 25° C., unless otherwise specified.

The rheology of the liquid composition can be easily adjusted by a type and particle size of the active material in the liquid composition, a solid content of the liquid composition, a type of a solvent used in the liquid composition, and addition of other components.

The liquid composition includes an active material and a dispersion medium, and may further include a binder, a dispersant, a conductive auxiliary agent, a solid electrolyte, and other components, as necessary.

### <<Solid Content>>

The solid content of the liquid composition is not particularly limited, and may be appropriately selected according to the intended purpose. From the viewpoint of easiness of exhibition of pseudoplasticity, the solid content of the liquid composition is preferably 40 percent by mass or greater, and more preferably 50 percent by mass or greater. From the viewpoint of reduction in residual stress in the coating film due to volume contraction during removal of the solvent, the solid content of the liquid composition is yet more preferably 60 percent by mass or greater.

In the present specification, the term “solid content of the liquid composition” is a fraction (percentage) of a mass of constituent components of the liquid composition excluding the dispersion medium and water relative to a total mass of the liquid composition.

A method for measuring the solid content of the liquid composition is not particularly limited, and may be appropriately selected according to the intended purpose. Examples of the method include: a method in which, if the composition of the liquid composition is known, the solid content is calculated according to the following equation; a method in which, if the composition of the liquid composition is unknown, the solid content of the liquid composition is measured according to JIS K5601-1-2; and the like.

### Equation:

Solid content={all solids (mass parts)/(all solids (mass parts)+dispersion medium (mass parts)+water (mass parts))}×100(%)

A device used for the measurement of the solid content of the liquid composition is not particularly limited, and may be appropriately selected according to the intended purpose. Examples of the device include a heat-dry moisture analyzer (MX-50, manufactured by A&D Company, Limited) and the like.

### <<Active Material>>

As the active material, a positive electrode active material or a negative electrode active material can be used. As the positive electrode active material or the negative electrode active material, a single material may be used alone, or two or more materials may be used in combination.

### —Positive Electrode Active Material—

The positive electrode active material is not particularly limited, and may be appropriately selected according to the intended purpose, as long as the positive electrode active material is a material that can reversibly occlude and release alkali metal ions. As the positive electrode active material, an alkali metal-containing transition metal compound can be used.

Examples of the alkali metal-containing transition metal compound include lithium-containing transition metal compounds, such as composite oxides including lithium and at least one element selected from the group consisting of cobalt, manganese, nickel, chromium, iron, and vanadium.

Examples of the lithium-containing transition metal compound include lithium cobaltate, lithium nickelate, lithium manganate, and the like.

At least a part of a surface of the alkali metal-containing transition metal compound is preferably coated with an ion-conductive oxide. The ion-conductive oxide is preferably a lithium-ion-conductive oxide.

The lithium-ion-conductive oxide is not particularly limited, and may be appropriately selected according to the intended purpose. Examples of the lithium-ion-conductive oxide include oxides represented by the general formula LiₓAO_{y} (A is B, C, Al, Si, P, S, Ti, Zr, Nb, Mo, Ta, Sc, V, Y, Ca, Sr, Ba, Hf, Ta, Cr, or W, and both x and y are positive numbers), and the like.

Specific examples of the lithium-ion-conductive oxide include Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, LiTaO₃, Li₂MoO₄, Li₂WO₄, and the like. Among the above lithium-ion conductive oxides, Li₄Ti₅O₁₂, Li₂ZrO₃, or LiNbO₃ is preferable. The lithium-ion-conductive oxide may be a composite oxide. As the composite oxide, any combination of lithium-ion-conductive oxides can be used. Examples of the composite oxide include Li₄SiO₄—Li₃BO₃, Li₄SiO₄—Li₃PO₄, and the like.

### —Negative Electrode Active Material—

The negative electrode active material is not particularly limited, and may be appropriately selected according to the intended purpose, as long as the negative electrode material is a material that can reversibly occlude and release alkali metal ions. Examples of the negative electrode active material include carbon materials, such as as graphite having a graphite crystal structure, and the like.

Examples of the carbon material include natural graphite, spherical or fibrous artificial graphite, non-graphitizing carbon (hard carbon), graphitizing carbon (soft carbon), and the like.

Examples of the negative electrode active material other than the carbon material include lithium titanate, titanium oxide, and the like.

As the negative electrode active material, a high capacity material, such as silicon, tin, silicon alloys, tin alloys, silicon oxide, silicon nitride, and tin oxide, can be suitably used from the viewpoint of an increase in energy density of a resultant lithium-ion secondary battery cell.

### —Particle Size of Active Material—

A particle size of the active material is not particularly limited, and may be appropriately selected according to the intended purpose. The particle size of the active material is preferably 0.5 μm or greater and 20 μm or less, and more preferably 3 μm or greater and 10 μm or less.

When the particle size of the active material is 0.5 μm or greater and 20 μm or less, an electrode active material layer having sufficiently small surface roughness with respect to a thickness of a separator layer, which is generally disposed on the active material layer, can be obtained. In addition, in the case where the liquid composition is discharged by a liquid discharge device, a discharge failure is unlikely to occur. When the particle size of the active material is 3 μm or greater and 10 μm or less, an electrode that can achieve excellent battery characteristics can be obtained.

In the present specification, a particle diameter at a peak of a particle size distribution of the active material in the liquid composition is calculated as the particle size of the active material.

A method for measuring the particle size of the active material is not particularly limited, and may be appropriately selected according to the intended purpose. For example, the particle size of the active material can be measured in accordance with ISO 13320:2009.

A device used for the measurement is not particularly limited, and may be appropriately selected according to the intended purpose. Examples of the device include a laser diffraction particle size distribution analyzer and the like.

### <<Dispersion Medium>>

The dispersion medium is not particularly limited, and may be appropriately selected according to the intended purpose. Examples of the dispersion medium include: water; ketone dispersion media, such as N-methyl-2-pyrrolidone, 2-pyrrolidone, N,N-dimethylacetamide, and cyclohexanone; ester dispersion media, such as butyl acetate; aromatic dispersion media, such as p-cymene, xylene, and mesitylene; alcohol dispersion media, such as 2-n-butoxymethanol, 2-dimethylethanol, ethylene glycol, and propylene glycol; olefin solvents; hydrocarbon dispersion media, such as tetradecane and dodecane; and the like. The above dispersion media may be used alone or in combination of two or more.

A convective heat transfer can be inhibited and a drying load can be reduced in the drying step by increasing the solid content of the liquid composition. Therefore, the dispersion medium is preferably a dispersion medium having excellent wettability to the active material, such as an ether dispersion medium, a ketone dispersion medium, an ester dispersion medium, a lactam dispersion medium, or a lactone dispersion medium

In the case where a sulfide solid electrolyte is included as the above-mentioned other components (optional components) of the liquid composition, a low polar solvent that does not have a hydroxyl group or a carboxyl group is preferably used for inhibiting a decomposition reaction of the sulfide solid electrolyte. Among low polar solvents, an ester dispersion medium is preferable from the viewpoint of improvement in dispersibility.

### <<Other Components>

### —Dispersant—

The dispersant is not particularly limited, and may be appropriately selected according to the intended purpose, as long as the dispersant can improve dispersibility of the active material and other particulate materials in the liquid composition. Examples of the dispersant include: polymer dispersants, such as carboxy methyl cellulose, polyethylene-based dispersants, polyethylene oxide-based dispersants, polypropylene oxide-based dispersants, polycarboxylic acid-based dispersants, naphthalenesulfonic acid formaldehyde condensate-based dispersants, polyethylene glycol-based dispersants, partially alkylated esters of polycarboxylic acid-based dispersants, polyether-based dispersants, and polyalkylene polyamine-based dispersants; low molecular weight dispersants, such as alkyl sulfonate-based dispersants, quaternary ammonium-based higher alcohol, alkylene oxide-based dispersants, polyvalent alcohol ester-based dispersants, and alkyl polyamine-based dispersants; inorganic dispersants, such as polyphosphate-based dispersants; and the like.

### —Conductive Auxiliary Agent—

The conductive auxiliary agent is not particularly limited, and may be appropriately selected according to the intended purpose. Examples of the conductive auxiliary agent include carbon materials, such as carbon black produced by a furnace method, an acetylene method, or a gasification method, carbon nanofibers, carbon nanotubes, graphene, graphite particles, and the like.

As the conductive auxiliary agent other than the carbon material, for example, metal particles or metal fibers, such as aluminum, can be used. The conductive auxiliary agent may be prepared as a composite formed with the active material in advance.

An amount of the conductive auxiliary agent relative to the active material is not particularly limited, and may be appropriately set according to the intended purpose. The amount of the conductive auxiliary agent is preferably 10 parts by mass or less, and more preferably 8 parts by mass or less, relative to 100 parts by mass of the active material. In addition, the amount of the conductive auxiliary agent is preferably 1 part by mass or greater relative to 100 parts by mass of the active material.

The amount of the conductive auxiliary agent being 10 parts by mass or less relative to 100 parts by mass of the active material is preferable because stability of the liquid composition is improved. The amount of the conductive auxiliary agent being 8 parts by mass or less relative to 100 parts by mass of the active material is preferable because stability of the liquid composition is further improved.

The amount of the conductive auxiliary agent being 1 part by mass or greater relative to 100 parts by mass of the active material is preferable because conductivity of the electrode active material layer is improved.

### —Solid Electrolyte—

The solid electrolyte is not particularly limited, and may be appropriately selected according to the intended purpose, as long as the solid electrolyte has electron insulating properties and ion conductivity, and does not react with the dispersion medium. Examples of the solid electrolyte include oxide solid electrolytes, sulfide solid electrolytes, and the like. Among the above solid electrolytes, a sulfide solid electrolyte is preferable because the sulfide solid electrolyte has a high plasticity and therefore a favorable interface between the solid electrolyte particles, or between the solid electrolyte and the active material, can be formed. From the viewpoint of excellent dispersibility comparable to the active material, the solid electrolyte is more preferably a crystalline argyrodite-type sulfide solute electrode.

Examples of the oxide solid electrode include compounds including an oxide atom, having ion conductivity with respect to a metal belonging to Group 1 or 2 of the periodic table, and having electron insulating properties, and the like.

In the present specification, the phrase “having electron insulating properties” means a state where a short circuit does not occur when a positive electrode and a negative electrode are disposed to face each other with the solid electrolyte layer being interposed between the positive electrode and the negative electrode.

In the present specification, the phrase “having ion conductivity” means that only ions move upon application of a potential difference, when a positive electrode and a negative electrode are disposed to face each other with the solid electrolyte layer being interposed between the positive electrode and the negative electrode.

Specific examples of the oxide solid electrode include LiₓₐLa_{ya}TiO₃[xa=0.3 to 0.7, ya=0.3 to 0.7] (LLT), Li_{xb}La_{yb}Zr_{zb}Mbb_{mb}O_{nb} (Mbb is at least one element selected from Al, Mg, Ca, Sr, V, Nb, Ta, Ti, Ge, In, and Sn, xb satisfies 5≤xb≤10, yb satisfies 1≤yb≤4, zb satisfies 1≤zb≤4, mb satisfies 0≤mb≤2, and nb satisfies 5≤nb≤20), Li_{xc}B_{yc}MCC_{zc}O_{nc} (Mcc is at least one element selected from C, S, Al, Si, Ga, Ge, In, and Sn, xc satisfies 0≤xc≤5, yc satisfies 0≤yc≤1, zc satisfies 0≤zc≤1, and nc satisfies 0≤nc≤6), Li_{xd} (Al, Ga)yₐ(Ti, Ge)_{za}Si_{ad}P_{md}O_{nd} (where 1≤xd≤3, 0≤yd≤1, 0≤zd≤2, 0≤ad≤1, 1≤md≤7, and 3≤nd≤13), Li₍₃₋₂ₓₑ₎MeeₓₑDeeO (xe is a number of 0 or more and 0.1 or less, Mee is a divalent metallic atom, and Dee is a halogen atom or a combination of two or more halogen atoms), Li_{xf}Si_{yf}O_{zf} (1≤xf≤5, 0<yf≤3, 1≤zf≤10), LixgSygOzg (1≤xg≤3,0<yg≤2, 1≤zg≤10), Li₃BO₃—Li₂SO₄, Li₂O—B₂O₃—P₂O₅, Li₂O—SiO₂, Li₆BaLa₂Ta₂O₁₂, Li₃PO_{(4-3/2w)}N_{w} (w is w<1), Li_{3.5}Zn_{0.25}GeO₄ having a lithium super ionic conductor (LISICON) crystal structure, La_{0.55}Li_{0.35}TiO₃ having a perovskite crystal structure, LiTi₂P₃O₁₂ having a natrium super ionic conductor (NASICON) crystal structure, Li_{1+xh+yh}(Al,Ga)ₓₕ(Ti,Ge)₂₋ₓₕSi_{yh}P_{3-yh}O₁₂ (where 0≤xh≤1, 0≤yh≤1), Li₇La₃Zr₂O₁₂ (LLZ) having a garnet crystal structure, and the like.

As the oxide solid electrode, a phosphorus compound including Li, P, and O is also desirable. Examples of the phosphorus compound include lithium phosphate (Li₃PO₄), LiPON that is lithium phosphate in which a part of oxygen atoms is substituted with nitrogen, LiPOD1 (D1 is at least one selected from the group consisting of Ti, V, Cr, Mn, Fe, Co, Ni, Cu, Zr, Nb, Mo, Ru, Ag, Ta, W, Pt, and Au), and the like.

LiAlON (Al is at least one selected from the group consisting of Si, B, Ge, Al, C, and Ga) or the like is also preferably used.

The sulfide solid electrolyte is, for example, roughly classified into a crystalline sulfide solid electrolyte and a glass sulfide solid electrolyte.

Examples of the crystalline sulfide solid electrolyte include Li_{9.54}Si_{1.74}P_{1.44}S_{11.7}Cl_{0.3}, Li_{9.6}P₃S₁₂, Li₉P₃S₉O₃, Li_{9.81}Sn_{0.81}P_{2.19}S₁₂, Li_{9.42}Si_{1.02}P_{2.1}S_{9.96}O_{2.04}, Li₁₀Ge(P₁₋ₓSbₓ)₂S₁₂ (0≤x≤0.15), Li₁₀SnP₂S₁₂, Li_{10.35}[M1₁₋ₓM2ₓ]_{1.35}P_{1.65}S₁₂ (M1 and M2 are each Si, Ge, Sn, As, or Sb, 0≤x≤0.15), Li₁₁Si₂PS₁₂, Li₁₁AlP₂S₁₂, Li_{3.45}Si_{0.45}P_{0.55}S₄, Li₆PS₅X (X═Cl, Br, or I), Li₅PS₄X₂ (X═Cl, Br, or I), Li_{5.5}PS_{4.5}Cl_{1.5}, Li_{5.35}Ca_{0.1}PS_{4.5}Cl_{1.55}, Li₆₊ₓMₓSb₁₋ₓS₅I (M═Si, Ge, or Sn, 0≤x≤1), Li₇P₂S₈I, γ-Li₃PS₄, Li₄MS₄ (M═Ge, Sn, or As), Li₄₋ₓSn₁₋ₓSbₓS₄ (0≤x≤0.15), Li₄₋ₓGe₁₋ₓPₓS₄ (0≤x≤0.15), Li₃₊₅ₓP₁₋ₓS₄ (0≤x≤0.3), and the like.

Examples of the glass sulfide solid electrolyte include Li₂S—P₂S₅, Li₂S—P₂S₅—LiI, Li₂S—P₂S₅—P₂O₅, Li₂S—P₂S₅—LiCl, Li₂S—SiS₂, Li₂S—SiS₂—P₂S₅, Li₂S—SiS₂—Al₂S₃, Li₂S—SiS₂—LiₓMO_{y} (M═Si, P, or Ge), and the like.

In addition, an Li₇P₃S₁₁ glass ceramic that is a partially crystallized glass sulfide solid electrolyte can also be used. A blending ratio between constituent components of the glass sulfide solid electrolyte is not particularly limited.

### ——Other Components——

Other components are not particularly limited, and may be appropriately selected according to the intended purpose. Examples of other components include dispersants, solid electrolytes, dispersion media, surfactants, pH adjusters, rust inhibitors, preservatives, fungicides, antioxidants, anti-reduction agents, evaporation accelerators, chelating agents, thickeners, ionic liquids, and the like.

### <Other Steps and Other Devices>

Other steps are not particularly limited, and may be appropriately selected according to the intended purpose. Examples of the other steps include a drying step, a pressing step, and the like.

Other devices are not particularly limited, and may be appropriately selected according to the intended purpose. Examples of the other devices include a drying device, a press, and the like.

### <<Drying Step and Drying Device>>

The drying step is a step that includes evaporating the solvent (the dispersion medium) from the liquid composition applied onto the substrate.

The drying device is a device configured to evaporate the solvent (the dispersion medium) from the liquid composition applied onto the substrate.

An intended shape of the electrode can be formed by alternately repeating the application step and the drying step to overlap the applied liquid composition portions to form the electrode. However, it is preferable that the application step is not performed after the drying step because there may be a small risk of reduction in binding force or increase in electron resistance due to formation of an interface within the active material layer.

The drying step is not particularly limited, and may be appropriately selected according to the intended purpose. Examples of the drying step include a method of drying from a bottom surface using a hotplate or the like, a method of drying from a surface using hot air or the like, a method of drying from inside using infrared rays or the like, and the like.

Drying conditions are not particularly limited, and may be appropriately selected according to the intended purpose. For example, a drying time can be shortened by setting the highest temperature within a range that is equal to or lower than the heat resistant temperature of the materials constituting the electrode.

### <<Pressing Step>>

The pressing step is a step that includes pressing the obtained electrode.

The press is a device configured to press the obtained electrode.

The press is not particularly limited, and may be appropriately selected according to the intended purpose. Examples of the press include a hydraulic roll press (manufactured by THANK-METAL CO., LTD.) and the like.

Conditions for the pressing are not particularly limited, and may be appropriately selected according to the intended purpose. For example, a target film thickness is determined to attain a target volumetric density, and a pressure, gap, and temperature may be set to attain the target film thickness.

The uniformity in film thickness described in the present disclosure refers to the uniformity in film thickness before the pressing step.

The volumetric density of the electrode according to the present disclosure is not particularly limited, and may be appropriately selected according to the intended purpose. In the case of the positive electrode, the volumetric density is preferably 2 g/cm³ or greater, and more preferably 3 g/cm³ or greater, from the viewpoint of formation of a conductive path. In addition, the volumetric density is preferably 4 g/cm³ or less, and more preferably 3.5 g/cm³ or less, from the viewpoint of formation of an ion conductive path.

In the case of the negative electrode, the volumetric density is preferably 2 g/cm³ or greater, and more preferably 2.5 g/cm³ or greater, from the viewpoint of formation of a conductive path. In addition, the volumetric density is preferably 4 g/cm³ or less, and more preferably 3.5 g/cm³ or less, from the viewpoint of formation of an ion conductive path.

A method for measuring the volumetric density is not particularly limited, and may be appropriately selected according to the intended purpose. One example will be described hereinafter.

A plurality of electrode pieces are punched out with a punch having a diameter of approximately 10 mm to 16 mm, and a weight of each electrode piece including a substrate is measured. A weight of the substrate is determined by measuring a weight of only the substrate in advance, and the weight of the substrate is subtracted from the measured weight of the electrode piece. The cross-section of the punched out electrode piece is measured by a white light interferometry laser microscope VK-X3000 (manufactured by KEYENCE CORPORATION), and an average film thickness is calculated. A volumetric density is then calculated according to the equation of the weight of the electrode/(the average film thickness x the surface area of the electrode).

Embodiments of the present disclosure will be described with reference to drawings hereinafter. However, the present disclosure is not limited to the following embodiments in any way.

In the drawings, the same constituent components are denoted by the same reference numerals, and redundant description may be omitted. The number, positions, shapes, and the like of the constituent components are not limited to the number, positions, shapes, and the like of the constituent components described in the present embodiment, and may be set to the number, positions, shapes, and the like preferable for implementing the present disclosure.

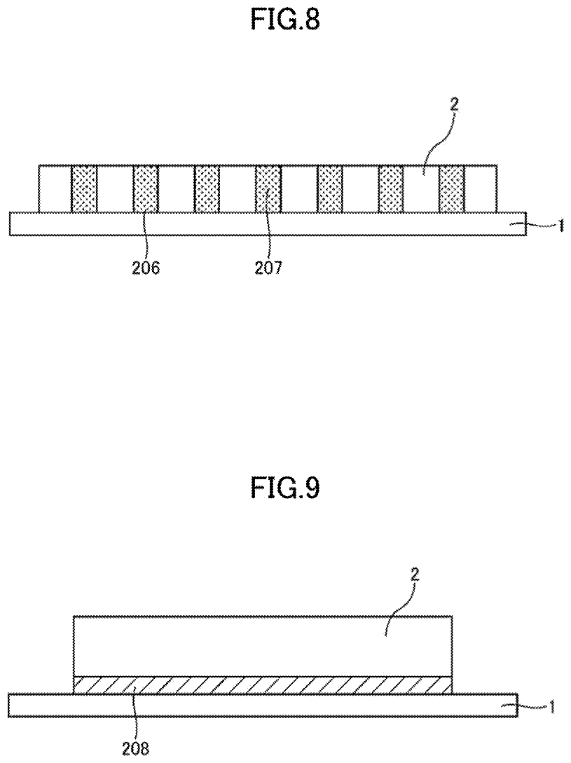

FIG. 8 is a schematic cross-sectional view illustrating an electrode obtained by the method for producing the electrode according to one embodiment of the present disclosure.

The active material layer 2 may have openings 206 as illustrated in FIG. 8.

The number of the openings 206 is preferably one or more, and more preferably two or more.

Each of the openings 206 may extend through the active material layer from the surface of the active material layer to the surface of the substrate, or may not extend to the surface of the substrate.

Each of the openings 206 may be hollow or filled with a material 207. In the case where the openings 206 are filled with the material 207, the material 207 may be a single material or a mixture of two or more materials. In either case, the material is different from materials constituting the active material layer. The material 207 is preferably a material including a solid electrolyte from the viewpoint of improvement in ion conductivity.

The active material layer having the openings 206 can be suitably produced by using an inkjet device as the apparatus for producing the active material layer because coating is easily controlled.

FIG. 9 is a schematic cross-sectional view illustrating an electrode obtained by the method for producing the electrode according to another embodiment of the present disclosure.

As illustrated in FIG. 9, an adhesive layer 208 may be disposed between the substrate 1 and the active material layer 2, and the adhesive layer 208 includes a metal that forms an alloy with lithium.

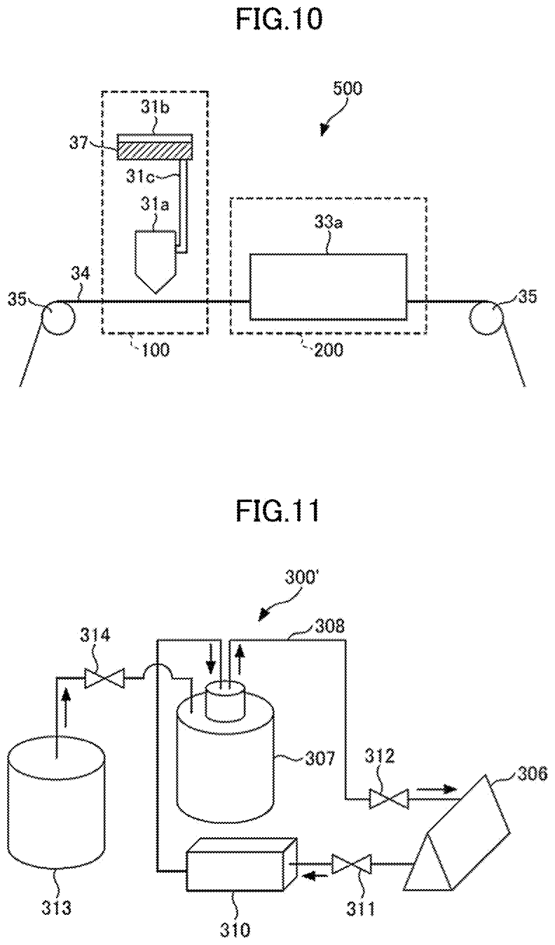

FIG. 10 is a schematic view illustrating the apparatus for producing the electrode according to one embodiment of the present disclosure.

The apparatus 500 for producing the electrode is a device configured to produce an active material layer using a liquid composition. The apparatus 500 for producing the electrode includes a printer 100, and optionally a heater 200. The printer is configured to apply the liquid composition onto a printing substrate 34 to form a liquid composition layer. The apparatus 500 for producing the electrode includes a transporting device 35 configured to transport the printing substrate 34. The transporting device 35 is configured to transport the printing substrate 34 at the preset speed in the order of the printer 100 and the optional heater 200.

### —Printer 100—

The printer 100 includes a printing device 31a that is configured to apply a liquid composition to form an active material layer on the printing substrate 34 and serves as an example of the applicator, a container 31b configured to accommodate the liquid composition, and a supply tube 31c configured to supply the liquid composition 37 stored in the container 31b to the printing device 31a.

The container 31b is configured to accommodate the liquid composition 37. The printer 100 is configured to discharge the liquid composition 37 from the printing device 31a to form a liquid composition layer in the form of a thin film on the printing substrate 34. The container 31b may be integrated with the apparatus for producing the electrode, or may be detachably mounted in the apparatus for producing the electrode. Moreover, the container 31b may be a container used for adding the liquid composition to a container integrated with the apparatus for producing the electrode, or a container detachably mounted in the apparatus for producing the electrode.

For the container 31b and the supply tube 31c, any container and any tube can be selected, as long as the container and the tube can stably store and supply the liquid composition 37, respectively.

### —Heater 200—

As illustrated in FIG. 10, the heater 200 includes a heating device 33a, and is configured to heat the liquid composition layer formed by the printer 100 using the heating device 33a to dry the remaining liquid component in the liquid composition layer, thereby performing the drying step. Thus, an active material layer can be formed. The heater 200 may perform removal of the liquid component under the reduced pressure.

The heating device 33a is not particularly limited, and may be appropriately selected according to the intended purpose. Examples of the heating device 33a include an IR heater, a hot air heater, and the like.

FIG. 11 is a schematic view illustrating the apparatus for producing the electrode according to another embodiment of the present disclosure.

The apparatus 300′ for producing the electrode controls a pump 310, a valve 311, and a valve 312 so that the liquid composition can be circulated through a liquid discharge head 306, a tank 307, and a tube 308.

In addition, the apparatus 300′ for producing the electrode is provided with an external tank 313. When the liquid composition in the tank 307 is reduced, the liquid composition can be supplied from the external tank 313 to the tank 307 by controlling the pump 310 and the valves 311, 312, and 314.

Use of the above apparatus for producing the electrode allows the liquid composition to be discharged at a desired area of the substrate.

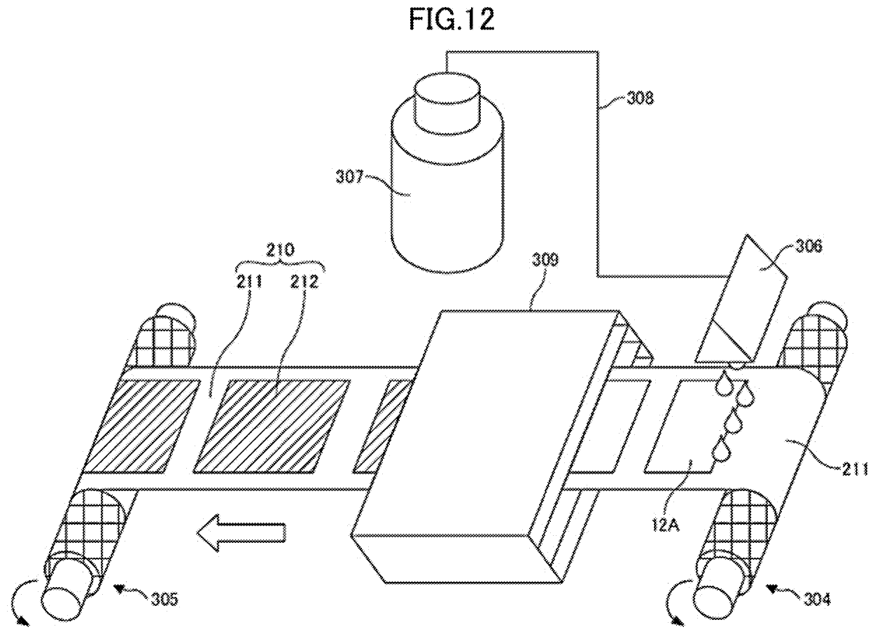

FIG. 12 is a schematic view illustrating the apparatus for producing the electrode according to another embodiment of the present disclosure. The method for producing the electrode includes a step that includes sequentially discharging a liquid composition 12A onto a substrate 211 using the apparatus for producing the electrode.

First, a long and narrow substrate 211 is prepared. Then, the substrate 211 is wound around a cylindrical core, and is set on a feeding roller 304 and a winding roller 305 so that the side of the substrate 211 on which an active material layer is formed comes on the upper side in FIG. 12. The feeding roller 304 and the winding roller 305 rotate in the counterclockwise direction to transport the substrate 211 from right to left in FIG. 12. Droplets of the liquid composition 12A are discharged from a liquid discharge head 306, which is disposed above the substrate 211 between the feeding roller 304 and the winding roller 305, onto the substrate 211 that is sequentially transported.

A plurality of liquid discharge heads 306 may be disposed in the direction substantially parallel or perpendicular to the transportation direction of the substrate 211. Next, the substrate 211, onto which the droplets of the liquid composition 12A are discharged, is transported to the heater 309 by the feeding roller 304 and the winding roller 305. As a result, an active material layer 212 is formed, thereby obtaining an electrode 210 in which the active material layer 212 is disposed on the substrate 211.

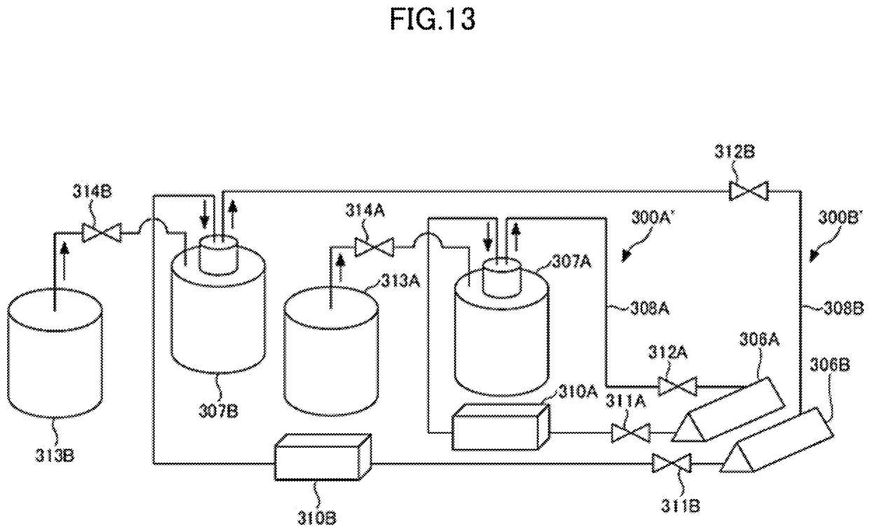

FIG. 13 is a schematic view illustrating a modification example of the apparatus for producing the electrode according to one embodiment of the present disclosure.

As illustrated in FIG. 13, an apparatus 300A′ for producing an electrode and an apparatus 300B′ for producing an electrode may be used in combination. Specifically, the liquid composition may be supplied from an external tank 313A and an external tank 313B, which are connected to a tank 307A and a tank 307B, respectively, and the liquid discharge head may include a plurality of heads 306A and 306B. In correspondence with the above configuration, a tube 308A and a tube 308B, a valve 311A, a valve 311B, a valve 312A, a valve 312B, a valve 314A, and a valve 314B, and pumps 310A and 310B may be included.

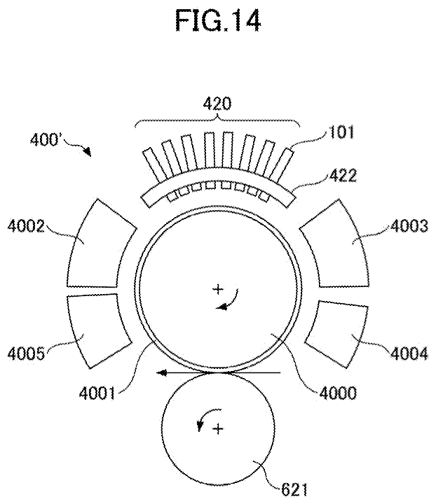

FIG. 14 is a configuration diagram illustrating an example of the printer employing an inkjet system and a transfer system as an applicator in the apparatus for producing the electrode according to one embodiment of the present disclosure (part 1). In the printer of FIG. 14, a drum-shaped intermediate transfer body is used.

A printer 400′ is an inkjet printer configured to transfer a liquid composition to a substrate via an intermediate transfer body 4001 to form an active material layer on the substrate.

The printer 400′ includes an inkjet applicator 420, a transfer drum 4000, a pretreatment device 4002, an absorbing device 4003, a heater 4004, and a cleaner 4005.

The inkjet applicator 420 includes a head module 422 provided with a plurality of heads 101.

The heads 101 discharge the liquid composition to the intermediate transfer body 4001 supported by the transfer drum 4000 to form a liquid composition film on the intermediate transfer body 4001. Each of the heads 101 is a line head in which nozzles are aligned in the range covering a width of a recording region for a maximum size of a usable substrate. Each of the heads 101 has a nozzle face that is a bottom surface in which nozzles are formed. The nozzle face faces the surface of the intermediate transfer body 4001 via a small gap. In the case of the present embodiment, the intermediate transfer body 4001 is configured along rotate on a circular orbit, and therefore the plurality of heads 101 are radially arranged.

The transfer drum 4000 faces an impression cylinder 621 and forms a transfer nip with the impression cylinder 621. The pretreatment device 4002 is configured to apply a reaction liquid for increasing the viscosity of the liquid composition, for example, onto the intermediate transfer body 4001 before discharge of the liquid composition from the heads 101.

The absorbing device 4003 is configured to absorb a liquid component of the liquid composition film on the intermediate transfer body 4001 before transferring.

The heater 4004 is configured to heat the liquid composition film on the intermediate transfer body 4001 before transferring. By heating the liquid composition, an active material layer is formed. In addition, the solvent is removed so that transferability to the substrate is improved.

The cleaner 4005 is configured to clean the intermediate transfer body 4001 to remove foreign matter, such as the ink or dust, remaining on the intermediate transfer body 4001 after transferring.

The outer peripheral surface of the impression cylinder 621 is pressed against the intermediate transfer body 4001. When the substrate passes through the transfer nip between the impression cylinder 621 and the intermediate transfer body 4001, the active material layer on the intermediate transfer body 4001 is transferred onto the substrate. The impression cylinder 621 may be configured to have at least one grip mechanism that holds an edge of the substrate on the outer peripheral surface of the impression cylinder 621.

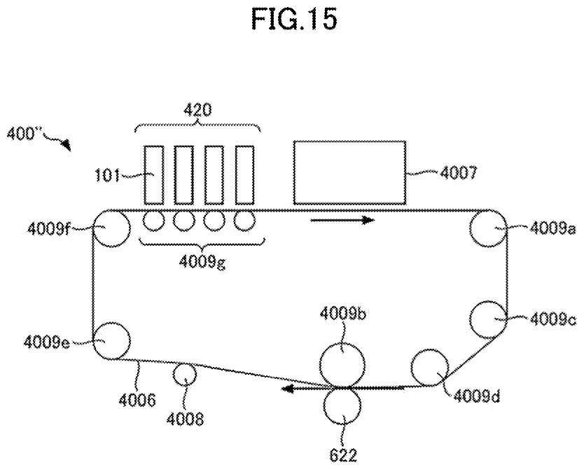

FIG. 15 is a configuration diagram illustrating another example of the printer employing the inkjet system and the transfer system as the applicator in the apparatus for producing the electrode according to one embodiment of the present disclosure (part 2). In the printer of FIG. 15, an endless belt type intermediate transfer body is used.

A printer 400″ is an inkjet printer configured to transfer a liquid composition to a substrate via an intermediate transfer belt 4006 to form an active material layer on the substrate.

The printer 400″ includes the inkjet applicator 420, a transfer roller 622, an intermediate transfer belt 4006, a heater 4007, a cleaning roller 4008, a driving roller 4009a, a counter roller 4009b, a foam maintaining roller 4009c, a foam maintaining roller 4009d, a foam maintaining roller 4009e, and a foam maintaining roller 4009f.

The printer 400″ is configured to discharge droplets of the liquid composition from a plurality of heads 101 provided to the inkjet applicator 420 to the outer peripheral surface of the intermediate transfer belt 4006. The liquid composition on the intermediate transfer belt 4006 is heated by the heater 4007 to undergo thermal polymerization, thereby forming an active material layer. The active material layer on the intermediate transfer belt 4006 is transferred to the substrate at the transfer nip at which the intermediate transfer belt 4006 and the transfer roller 622 face each other. After transferring, the surface of the intermediate transfer belt 4006 is cleaned by the cleaning roller 4008.

The intermediate transfer belt 4006 is supported by the driving roller 4009a, the counter roller 4009b, the foam maintaining roller 4009c, the foam maintaining roller 4009d, the foam maintaining roller 4009e, the foam maintaining roller 4009f, and a plurality of supporting rollers 4009g, and moves in the direction indicated by the arrow in FIG. 15. The supporting rollers 4009g disposed to face the heads 101 are configured to maintain the intermediate transfer belt 4006 to be in the tensioned state when ink droplets are discharged from the heads 101.

### (Electrochemical Element)

The electrochemical element includes the electrode obtained by the method for producing the element according to one embodiment of the present disclosure, and may further include other members, as necessary. The electrochemical element according to one embodiment of the present disclosure may include a positive electrode, a negative electrode, a separator including an electrolyte disposed between the positive electrode and the negative electrode, and a housing.

In the case where a solid electrolyte or a gel electrolyte is used, the separator can be omitted.

The method for producing the electrochemical element can be appropriately selected from methods known in the art, except that the electrode is obtained by the method for producing the electrode of the present disclosure.

### <Electrolyte>

As the electrolyte, an aqueous electrolytic solution or a nonaqueous electrolytic solution can be used.

### —Aqueous Electrolytic Solution—

The aqueous electrolytic solution is an aqueous solution in which an electrolyte salt is dissolved in water.

The electrolyte salt in the aqueous electrolytic solution is not particularly limited, and may be appropriately selected according to the intended purpose. Examples of the electrolyte salt include sodium hydroxide, potassium hydroxide, sodium chloride, potassium chloride, ammonium chloride, zinc chloride, zinc acetate, zinc bromide, zinc iodide, zinc tartrate, zinc perchloride, and the like.

—Nonaqueous Electrolyte—As the nonaqueous electrolyte, a nonaqueous electrolytic solution, a solid electrolyte, or a gel electrolyte can be used.

### ——Nonaqueous Electrolytic Solution——

The nonaqueous electrolytic solution is an electrolytic solution in which an electrolyte is dissolved in a nonaqueous solvent.

The nonaqueous solvent is not particularly limited, and may be appropriately selected according to the intended purpose. For example, an aprotic organic solvent is preferably used as the nonaqueous solvent. As the aprotic organic solvent, a carbonate-based organic solvent, such as a chain carbonate and a cyclic carbonate, can be used. Among the carbonate-based organic solvents, a chain carbonate is preferable from the viewpoint of high dissolution power with respect to the electrolyte salt. In addition, the aprotic organic solvent preferably has a low viscosity.

Examples of the chain carbonate include dimethyl carbonate (DMC), diethyl carbonate (DEC), methyl ethyl carbonate (EMC), and the like.

An amount of the chain carbonate in the nonaqueous solvent is preferably 50 percent by mass or greater. When the amount of the chain carbonate in the nonaqueous solvent is 0 percent by mass or greater, an amount of a cyclic material (e.g., cyclic carbonate and cyclic ester) having a high dielectric constant, which is a component other than the chain carbonate, in the nonaqueous solvent becomes small. Therefore, even when a nonaqueous electrolytic solution of a high concentration, i.e., 2 M or higher, is produced, a viscosity of the nonaqueous electrolytic solution is low, thus inhibiting penetration of the nonaqueous electrolytic solution into the electrode, and achieving excellent ion diffusion.

Examples of the cyclic carbonate include propylene carbonate (PC), ethylene carbonate (EC), butylene carbonate (BC), vinylene carbonate (VC), and the like.

Examples of the nonaqueous solvent other than the carbonate-based organic solvent include: ester-based organic solvents, such as cyclic esters and chain esters; ether-based organic solvents, such as cyclic ethers and chain ethers; and the like.

Examples of the cyclic esters include γ-butyrolactone (γBL), 2-methyl-γ-butyrolactone, acetyl-γ-butyrolactone, γ-valerolactone, and the like.

Examples of the chain esters include alkyl propipnate, dialkyl malonate, alkyl acetate (e.g., methyl acetate (MA) and ethyl acetate), alkyl formate (e.g., methyl formate (MF) and ethyl formate), and the like.

Examples of the cyclic ethers include tetrahydrofuran, alkyl tetrahydrofuran, alkoxy tetrahydrofuran, dialkoxy tetrahydrofuran, 1,3-dioxolane, alkyl-1,3-dioxolane, 1,4-dioxolane, and the like.

Examples of the chain ethers include 1,2-dimethoxyethane (DME), diethyl ether, ethylene glycol dialkyl ether, diethylene glycol dialkyl ether, triethylene glycol dialkyl ether, tetraethylene glycol dialkyl ether, and the like.

The electrolyte salt in the nonaqueous electrolytic solution is not particularly limited, as long as the electrolyte salt has high ion conductivity and can be dissolved in a nonaqueous solvent.

The electrolyte salt in the nonaqueous electrolytic solution preferably includes a halogen atom.

Examples of a cation constituting the electrolyte salt include lithium ions and the like.

Examples of an anion constituting the electrolyte salt include BF₄⁻, PF₆⁻, AsF₆⁻, CF₃SO₃⁻, (CF₃SO₂)₂N⁻, (C₂F₅SO₂)₂N⁻, and the like.

The lithium salt is not particularly limited, and may be appropriately selected according to the intended purpose. Examples of the lithium salt include lithium hexafluorophosphate (LiPF₆), lithium fluoroborate (LiBF₄), lithium hexafluoroarsenate (LiAsF₆), lithium trifluoromethansulfonate (LiCF₃SO₃), lithium bis(trifluoromethylsulfonyl)imide (LiN(C₃SO₂)₂), lithium bis(pentafluoroethylsulfonyl)imide (LiN(C₂F₅SO₂)₂), and the like. Among the above lithium salts, LiPF₆ is preferable from the viewpoint of ion conductivity, and LiBF₄ is preferable from the viewpoint of stability.

As the electrolyte salt in the nonaqueous electrolytic solution, a single electrolyte salt may be used, or two or more electrolyte salts may be used in combination.

A concentration of the electrolyte salt in the nonaqueous electrolytic solution is not particularly limited, and may be appropriately selected according to the intended purpose. In the case where the nonaqueous electrochemical element is of a swing system, the concentration of the electrolyte salt is preferably 1 mol/L to 2 mol/L. In the case where the nonaqueous electrochemical element is a reserve type, the concentration of the electrolyte salt is preferably 2 mol/L to 4 mol/L.

### ——Solid Electrolyte——

As the solid electrolyte, the same solid electrolyte as the solid electrolyte described in the section of <<Solid electrolyte>> can be used.

### ——Gel Electrolyte——

The gel electrolyte is not particularly limited, and may be appropriately selected according to the intended purpose, as long as the gel electrolyte has ion conductivity. Examples of a polymer constituting a network structure of the gel electrolyte include polyethylene oxide, polypropylene oxide, polyacrylonitrile, polymethyl methacrylate, polyvinyl chloride, vinylidene fluoride-hexafluoropropylene copolymers, polyethylene carbonate, and the like.

Solvent molecules retained in the gel electrolyte are not particularly limited, and may be appropriately selected according to the intended purpose. Examples of the solvent molecules include ionic liquids and the like.

Examples of the ionic liquids include 1-methyl-1-propylpyrrolidinium bis(fluorosulfonylimide), 1-butyl-1-methylpyrrolidinium bis(fluorosulfonylimide), 1-methyl-1-propylpiperidinium bis(fluorosulfonylimide), 1-ethyl-3-methylimidazolium bis(fluorosulfonylimide), 1-methyl-3-propylimidazolium bis(fluorosulfonylimide), N,N-diethyl-N-methyl-N-(2-methoxyethyl) ammonium bis(fluorosulfonyl)imide, and the like.

Moreover, a mixture of a liquid and a lithium salt may be used, and the liquid is a liquid, such as tetraglyme, propylene carbonate, fluoroethylene carbonate, ethylene carbonate, and diethyl carbonate.

The above gel electrolytes may be used alone or in combination of two or more.

As the electrolyte material that is dissolved or dispersed in the liquid to form the gel electrolyte, a solution in which a polymer compound and an ionic liquid or a lithium salt are dissolved may be used. Moreover, a gel electrolyte precursor, such as a polyethylene oxide or polypropylene oxide including acrylate groups at both terminals, and a solution in which the ionic liquid or the lithium salt is dissolved may be used in combination.

### <Separator>

The separator is disposed between the negative electrode and the positive electrode, as necessary, in order to inhibit a short circuit between the negative electrode and the positive electrode.

Examples of the separator include: paper, such as kraft paper, vinylon mixed paper, and synthetic pulp mixed paper; polyolefin nonwoven fabrics, such as cellophane, polyethylene graft membranes, and polypropylene melt-blown nonwoven fabrics; polyamide nonwoven fabrics; glass fiber nonwoven fabrics; micropore membranes; and the like.

A size of the separator is not particularly limited, as long as the separator can be used for the electrochemical element.

The separator may have a single layer structure or a laminate structure.

In the case where an aqueous electrolytic solution or nonaqueous electrolytic solution is used as the electrolyte, a separator is disposed. In the case where a solid electrolyte or a gel electrolyte is used as the electrolyte, the separator can be omitted.

### <Housing>

The housing is not particularly limited, and may be appropriately selected from housings known in the related art, as long as the electrode, the electrolyte, the separator, the solid electrolyte, or the gel electrolyte can be sealed by the housing.

A form of the electrochemical element is not particularly limited. Examples of the form of the electrochemical element include a laminate cell, a cylinder cell in which sheet electrodes and a separator are spirally arranged, a cylinder cell having an inside-out structure, in which pellet electrodes and separator are combined, a coin cell in which pellet electrodes and separator are stacked, and the like.

Embodiment of the electrochemical element in association with the present disclosure will be described with reference to the drawings, hereinafter. However, the present disclosure is not limited to the following embodiments in any way.

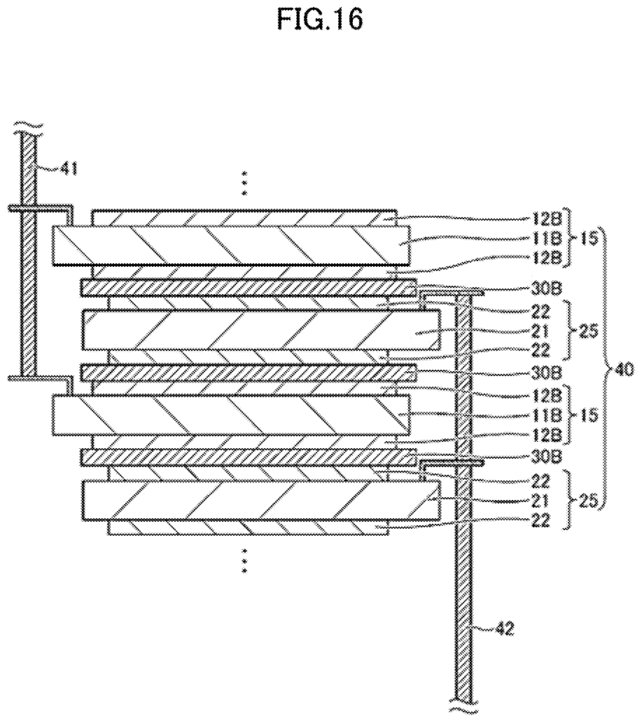

FIG. 16 is a schematic cross-sectional view illustrating the electrochemical element according to one embodiment of the present disclosure.

An electrode element 40 includes a negative electrode 15 and a positive electrode 25, and the negative electrode 15 and the positive electrode 25 are stacked with a separator 30B being interposed between the negative electrode 15 and the positive electrode 25. The positive electrode 25 is stacked on both sides of the negative electrode 15. In addition, a lead wire 41 is connected to a negative electrode substrate 11B, and a lead wire 42 is connected to a positive electrode substrate 21. In the case of a solid electrochemical element, the separator 30B can be replaced by a solid electrolyte or a gel electrolyte.

In the negative electrode 15, a negative electrode active material layer 12B is formed on both sides of the negative electrode substrate 11B.

In the positive electrode 25, a positive electrode active material layer 22 is formed on both sides of the positive electrode substrate 21.

The number of the negative electrodes 15 and the positive electrodes 25 stacked in the electrode element 40 is not particularly limited, and may be appropriately selected according to the intended purpose. The number of the negative electrodes 15 and the number of the positive electrodes 25 in the electrode element 40 may be the same or different.

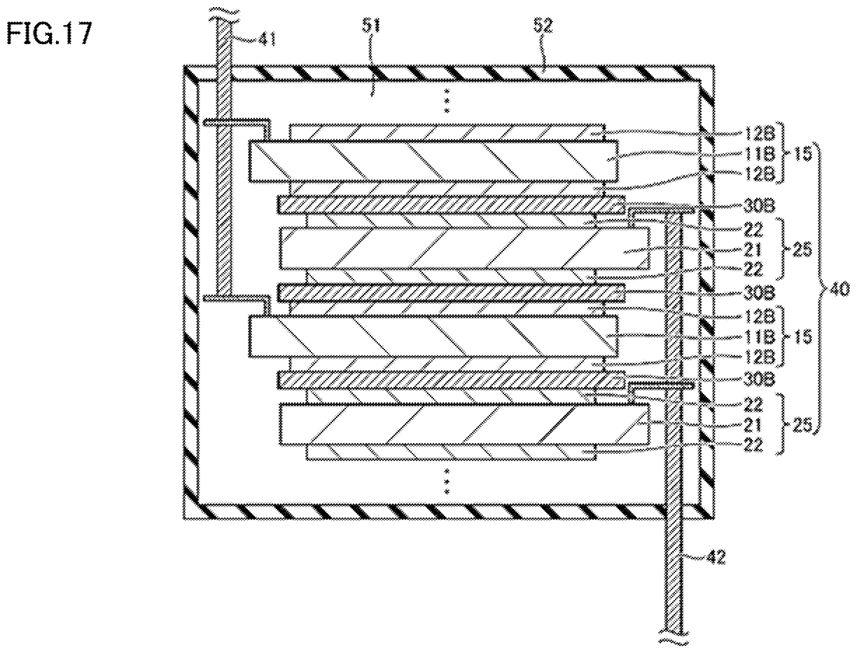

FIG. 17 is a schematic cross-sectional view illustrating the electrochemical element according to another embodiment of the present disclosure.

The electrode element 40 has the same configuration as the configuration illustrated in FIG. 16. In the case where the electrochemical element is a liquid-based electrochemical element, an electrolyte layer 51 is formed by injecting an aqueous electrolytic solution or nonaqueous electrolyte into the electrode element 40, and the resultant electrode element is sealed by a housing 52. In the electrochemical element, the lead wire 41 and the lead wire 42 are extended to the outside of the housing 52. In the case where the electrochemical element is a solid electrochemical element, the separator 30 can be replaced by a solid electrolyte or a gel electrolyte.

### (Apparatus and Method for Producing Electrochemical Element)

The apparatus for producing the electrochemical element in association with the present disclosure includes an electrode production device and an element fabrication device, and may further include other devices, as necessary. The electrode production device is configured to produce an electrode using the apparatus for producing the electrode of the present disclosure. The element fabrication device is configured to produce an electrochemical element using the electrode.

The method for producing the electrochemical element in association with the present disclosure includes an electrode production step and an element fabrication step, and may further include other steps, as necessary. The electrode production step is a step that includes producing an electrode according to the method for producing the electrode of the present disclosure. The element fabrication step is a step that includes producing an electrochemical element using the electrode.

### <Electrode Production Device and Electrode Production Step>

The electrode production device includes a container and an applicator configured to apply a liquid composition stored in the container onto a substrate. The electrode production device may further include other devices, as necessary.

The electrode production step includes an application step, which is a step that includes applying the liquid composition, and may further include other steps, as necessary.

As the container, the applicator, and the application step, the features described in (Method and apparatus for producing electrode) can be appropriately applied.

### <Element Fabrication Device and Element Fabrication Step>

The element fabrication device is a device configured to produce an electrochemical element using the electrode.

The element fabrication step is a step that includes producing an electrochemical element using the electrode.

A method for producing the electrochemical element using the electrode is not particularly limited, and may be appropriately selected from production methods of electrochemical elements known in the related art. Examples of the method include: a method in which at least one selected from the group consisting of installation of a counter electrode, winding or stacking, and housing in a container is performed to form the electrochemical element; and the like.

The element fabrication step does not necessarily include all the processes of the element fabrication, and may include part of the processes of the formation of the electrode element.

### [Applications of Electrochemical Element]

The electrochemical element can be suitably used as a secondary battery.

The application of the electrochemical element is not particularly limited. Examples of the application of the electrochemical element include laptop computers, stylus-input computers, mobile computers, electronic book readers, mobile phones, portable facsimiles, portable copiers, portable printers, headphone stereos, video players and cameras, liquid crystal televisions, handy cleaners, portable CD players, minidisc players, transceivers, electronic organizers, calculators, memory cards, portable tape recorders, radios, backup power supplies, motors, lighting equipment, toys, game consoles, clocks, strobes, cameras, motor vehicles, and the like.

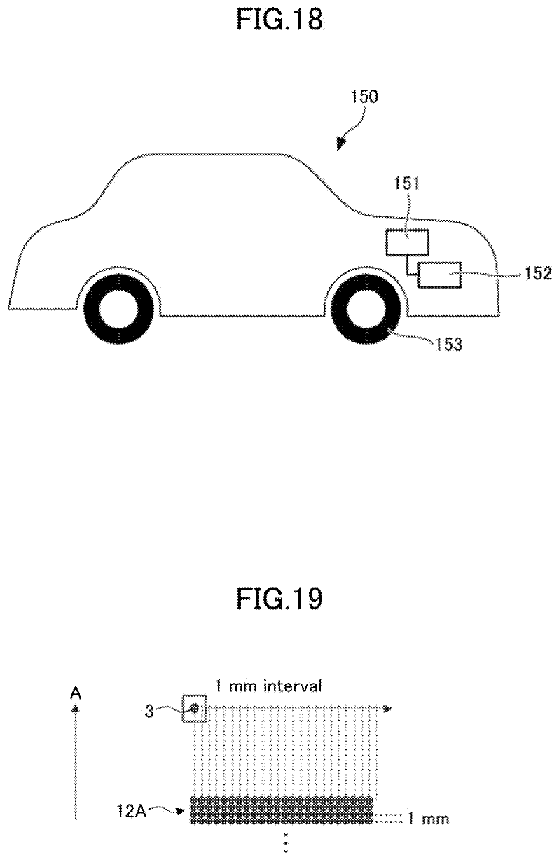

FIG. 18 is a schematic view illustrating an example of a vehicle serving as the electrochemical element according to one embodiment of the present disclosure.

The vehicle 150 is, for example, an electric vehicle. The vehicle 150 includes a motor 151, an electrochemical element 152, and wheels 153.

The electrochemical element 152 is the electrochemical element in association with the present disclosure. The electrochemical element 152 is configured to supply the electric power to the motor 151, thereby driving the motor 151. The driven motor 151 can drive the wheels 153. As a result, the vehicle 150 can move.

Since the vehicle 150 includes the electrochemical element 152, a short circuit between the positive electrode and the negative electrode is inhibited, and the vehicle is driven by the electric power supplied from the electrochemical element having excellent battery characteristics. Therefore, the vehicle can be moved safely and efficiently.

The vehicle 150 is not limited to an electric vehicle, and may be a plug-in hybrid electric vehicle (PHEV), a hybrid electric vehicle (HEV), or a train or motorcycle that can travel using a diesel engine and the electrochemical element in combination. Alternatively, the vehicle 150 may be a transport robot, which is used in factories or the like, and can move using the electrochemical element alone, or a combination of an engine and the electrochemical element. Further, the vehicle 150 may be an object that does not move as a whole, but has a movable portion, such as an assembly robot that is disposed in a production line of a factory, and is capable of moving an arm or the like using the electrochemical element or a combination of an engine and the electrochemical element.

### EXAMPLES

The present disclosure will be concretely described through Examples and Comparative Examples, but the present disclosure shall not be construed as being limited by Examples below in any way. In Examples and Comparative Examples below, “part(s)” denotes “part(s) by mass” and “%” denotes “percent by mass” unless otherwise specified.

### <Preparation of Liquid Composition>

### <<Liquid Composition 1>>

Lithium nickel cobalt manganate (NCM1) (average primary particle diameter: 3.5 μm, manufactured by TOYOSHIMA Manufacturing Co., Ltd.) serving as an active material, and N-methyl-2-pyrrolidone (NMP) (manufactured by Tokyo Chemical Industry Co., Ltd.) serving as a solvent were mixed at a blending ratio at which a solid content (a concentration of the active material) was to be 85 percent by weight, thereby producing a wet powder. The wet powder was subjected to a dispersion treatment by an ultrasonic homogenizer (manufactured by NIPPON SEIKI CO., LTD.), thereby obtaining Liquid Composition 1.

### <<Liquid Compositions 2 to 57>>

A liquid composition was obtained in the same manner as the preparation of Liquid Composition 1, except that the materials, the weight ratio, and the solid content were changed as presented in Tables 1 to 6. The solid content refers to a fraction of a sum of the active material, a binder, a conductive auxiliary agent, a dispersant, a solid electrolyte, and other components relative to a total amount of the liquid composition.

TABLE 1

| | | | | Composition | | | | |
|---|---|---|---|---|---|---|---|---|
| | | Physical properties | | | | Dispersion | Other components | |
| Liquid | | Viscosity | Viscosity | Active material | | medium | Binder | |
| Composition No. | Electrode | η0.1 | η1000 | Material | Wt ratio | Material | Material | Wt ratio |
| Liquid Composition 1 | Positive | 10000 | 30 | NCM1 | 100 | NMP | — | — |
| | electrode | | | | | | | |
| Liquid Composition 2 | Positive | 1000 | 20 | NCM1 | 100 | NMP | — | — |
| | electrode | | | | | | | |
| Liquid Composition 3 | Positive | 500 | 10 | NCM1 | 100 | NMP | — | — |
| | electrode | | | | | | | |
| Liquid Composition 4 | Positive | 20000 | 40 | NCM2 | 100 | NMP | — | — |
| | electrode | | | | | | | |
| Liquid Composition 5 | Positive | 5000 | 20 | NCA | 100 | NMP | — | — |
| | electrode | | | | | | | |
| Liquid Composition 6 | Negative | 10000 | 150 | SiO | 100 | NMP | — | — |
| | electrode | | | | | | | |
| Liquid Composition 7 | Positive | 5000 | 20 | NCM1 | 100 | Butyl | — | — |
| | electrode | | | | | butyrate | | |
| Liquid Composition 8 | Positive | 5000 | 20 | NCM1 | 100 | Butyl | — | — |
| | electrode | | | | | isobutyrate | | |

| | Composition | | | | | | |
|---|---|---|---|---|---|---|---|
| | Other components | | | | | | |
| | Conductive auxiliary | | Solid electrolyte | | Dispersant | | |
| Liquid | | Wt | | Wt | | Wt | Solid content |
| Composition No. | Material | ratio | Material | ratio | Material | ratio | [wt %] |
| Liquid Composition 1 | — | — | — | — | — | — | 80 |
| Liquid Composition 2 | — | — | — | — | — | — | 70 |
| Liquid Composition 3 | — | — | — | — | — | — | 60 |
| Liquid Composition 4 | — | — | — | — | — | — | 85 |
| Liquid Composition 5 | — | — | — | — | — | — | 80 |
| Liquid Composition 6 | — | — | — | — | — | — | 50 |
| Liquid Composition 7 | — | — | — | — | — | — | 80 |
| Liquid Composition 8 | — | — | — | — | — | — | 80 |

TABLE 2

| | | | | Compoition | | | | |
|---|---|---|---|---|---|---|---|---|
| | | Physical properties | | | | Dispersion | Other components | |
| Liquid | | Viscosity | Viscosity | Active material | | medium | Binder | |
| Composition No. | Electrode | η0.1 | η1000 | Material | Wt ratio | Material | Material | Wt ratio |
| Liquid | Positive | 5000 | 20 | NCM1 | 100 | Methyl | — | — |
| Composition 9 | electrode | | | | | hexanoate | | |
| Liquid | Positive | 5000 | 20 | NCM1 | 100 | Ethyl | — | — |
| Composition 10 | electrode | | | | | hexanoate | | |
| Liquid | Positive | 5000 | 20 | NCM1 | 100 | Methyl | — | — |
| Composition 11 | electrode | | | | | heptanoate | | |
| Liquid | Positive | 5000 | 20 | NCM1 | 100 | Ethyl | — | — |
| Composition 12 | electrode | | | | | heptanoate | | |
| Liquid | Positive | 5000 | 20 | NCM1 | 100 | Methyl | — | — |
| Composition 13 | electrode | | | | | octanoate | | |
| Liquid | Positive | 5000 | 20 | NCM1 | 100 | Dimethyl | — | — |
| Composition 14 | electrode | | | | | carbonate | | |
| Liquid | Positive | 5000 | 20 | NCM1 | 100 | DMF | — | — |
| Composition 15 | electrode | | | | | | | |
| Liquid | Negative | 25000 | 200 | Gr | 100 | Water | — | — |
| Composition 16 | electrode | | | | | | | |
| Liquid | Positive | 3000 | 20 | NCM1 | 100 | Anisole | — | — |
| Composition 17 | electrode | | | | | | | |
| Liquid | Positive | 3000 | 20 | NCM1 | 100 | p-Cymene | — | — |
| Composition 18 | electrode | | | | | | | |

| | Compoition | | | | | | |
|---|---|---|---|---|---|---|---|
| | Other components | | | | | | |
| | Conductive auxiliary | | Solid electrolyte | | Dispersant | | |
| Liquid | | Wt | | Wt | | Wt | Solid content |
| Composition No. | Material | ratio | Material | ratio | Material | ratio | [wt %] |
| Liquid Composition 9 | — | — | — | — | — | — | 80 |
| Liquid Composition 10 | — | — | — | — | — | — | 80 |
| Liquid Composition 11 | — | — | — | — | — | — | 80 |
| Liquid Composition 12 | — | — | — | — | — | — | 80 |
| Liquid Composition 13 | — | — | — | — | — | — | 80 |
| Liquid Composition 14 | — | — | — | — | — | — | 80 |
| Liquid Composition 15 | — | — | — | — | — | — | 80 |
| Liquid Composition 16 | — | — | — | — | CMCNa | 1 | 55 |
| Liquid Composition 17 | — | — | — | — | SC0708A | 1 | 60 |
| Liquid Composition 18 | — | — | — | — | S3000 | 1 | 60 |

TABLE 3

| | | Physical | | Composition | | | | |
|---|---|---|---|---|---|---|---|---|
| Liquid | | properties | | | | Dispersion | Other components | |
| Composition | | Viscosity | Viscosity | Active material | | medium | Binder | |
| No. | Electrode | η0.1 | η1000 | Material | Wt ratio | Material | Material | Wt ratio |
| Liquid Composition 19 | Positive | 1000 | 50 | NCM1 | 100 | NMP | PVdF | 1.5 |
| | electrode | | | | | | | |
| Liquid Composition 20 | Positive | 10000 | 100 | NCM1 | 100 | NMP | PVdF | 1.5 |
| | electrode | | | | | | | |
| Liquid Composition 21 | Positive | 20000 | 150 | NCM1 | 100 | NMP | PVdF | 1.5 |
| | electrode | | | | | | | |
| Liquid Composition 22 | Positive | 50000 | 250 | NCM1 | 100 | NMP | PVdF | 1.5 |
| | electrode | | | | | | | |
| Liquid Composition 23 | Positive | 40000 | 50 | NCM1 | 100 | NMP | PVdF | 1.5 |
| | electrode | | | | | | | |
| Liquid Composition 24 | Positive | 30000 | 50 | NCM1 | 100 | NMP | PMMA | 1.5 |
| | electrode | | | | | | | |
| Liquid Composition 25 | Positive | 20000 | 100 | NCM1 | 100 | Methyl | PBMA | 1.5 |
| | electrode | | | | | butyrate | | |
| Liquid Composition 26 | Positive | 30000 | 100 | NCM1 | 100 | Methyl | PBMA | 1.5 |
| | electrode | | | | | hexanoate | | |
| Liquid Composition 27 | Positive | 33000 | 110 | NCM1 | 100 | Methyl | PBMA | 1.5 |
| | electrode | | | | | heptanoate | | |
| Liquid Compositio 28 | Positive | 35000 | 130 | NCM1 | 100 | Methyl | PBMA | 1.5 |
| | electrode | | | | | octanoate | | |

| | Composition | | | | | | |
|---|---|---|---|---|---|---|---|
| | Other components | | | | | | |
| Liquid | Conductive auxiliary | | Solid electrolyte | | Dispersant | | |
| Composition | | Wt | | Wt | | Wt | Solid content |
| No. | Material | ratio | Material | ratio | Material | ratio | [wt %] |
| Liquid Composition 19 | AB | 1.5 | — | — | BYK-ET3000 | 0.15 | 60 |
| Liquid Composition 20 | AB | 1.5 | — | — | BYK-ET3000 | 0.15 | 65 |
| Liquid Composition 21 | AB | 1.5 | — | — | BYK-ET3000 | 0.15 | 70 |
| Liquid Composition 22 | AB | 1.5 | — | — | BYK-ET3000 | 0.15 | 72 |
| Liquid Composition 23 | AB:MWCNT | 1.0:0.5 | — | — | BYK-ET3000 | 0.5 | 60 |
| Liquid Composition 24 | MWCNT | 1 | — | — | BYK-ET3000 | 0.5 | 65 |
| Liquid Composition 25 | MWCNT | 1 | — | — | S13940 | 0.75 | 65 |
| Liquid Composition 26 | MWCNT | 1 | — | — | S13940 | 0.75 | 65 |
| Liquid Composition 27 | MWCNT | 1 | — | — | S13940 | 0.75 | 65 |
| Liquid Compositio 28 | MWCNT | 1 | — | — | S13940 | 0.75 | 65 |

TABLE 4

| | | | | Composition | | | | |
|---|---|---|---|---|---|---|---|---|
| | | Physical properties | | | | Dispersion | Other components | |
| Liquid | | Viscosity | Viscosity | Active material | | medium | Binder | |
| Composition No. | Electrode | η0.1 | η1000 | Material | Wt ratio | Material | Material | Wt ratio |
| Liquid | Positive | 10000 | 100 | NCM1 | 100 | Methyl | PDEAmEMA | 1.5 |
| Composition 29 | electrode | | | | | hexanoate | | |
| Liquid | Positive | 13000 | 110 | NCM1 | 100 | Methyl | PDEAmEMA | 1.5 |
| Composition 30 | electrode | | | | | heptanoate | | |
| Liquid | Positive | 15000 | 120 | NCM1 | 100 | Methyl | PDEAmEMA | 1.5 |
| Composition 31 | electrode | | | | | octanoate | | |
| Liquid | Positive | 10000 | 100 | NCM1 | 100 | Methyl | P(THFMA- | 1.5 |
| Composition 32 | electrode | | | | | hexanoate | DEAmEMA) | |
| Liquid | Positive | 11000 | 110 | NCM1 | 100 | Ethyl | P(THFMA- | 1.5 |
| Composition 33 | electrode | | | | | hexanoate | DEAmEMA) | |
| Liquid | Positive | 12000 | 110 | NCM1 | 100 | Methyl | P(THFMA- | 1.5 |
| Composition 34 | electrode | | | | | heptanoate | DEAmEMA) | |
| Liquid | Positive | 14000 | 120 | NCM1 | 100 | Ethyl | P(THFMA- | 1.5 |
| Composition 35 | electrode | | | | | heptanoate | DEAmEMA) | |
| Liquid | Positive | 14000 | 120 | NCM1 | 100 | Methyl | P(THFMA- | 1.5 |
| Composition 36 | electrode | | | | | octanoate | DEAmEMA) | |
| Liquid | Positive | 10000 | 100 | NCM1 | 100 | Methyl | P(BMA- | 1.5 |
| Composition 37 | electrode | | | | | hexanoate | DEAmEMA) | |
| Liquid | Positive | 11000 | 100 | NCM1 | 100 | Methyl | P(BMA- | 1.5 |
| Composition 38 | electrode | | | | | heptanoate | DEAmEMA) | |

| | Composition | | | | | | |
|---|---|---|---|---|---|---|---|
| | Other components | | | | | | |
| | Conductive auxiliary | | Solid electrolyte | | Dispersant | | |
| Liquid | | Wt | | Wt | | Wt | Solid content |
| Composition No. | Material | ratio | Material | ratio | Material | ratio | [wt %] |
| Liquid Composition 29 | MWCNT | 1 | — | — | S13940 | 0.75 | 65 |
| Liquid Composition 30 | MWCNT | 1 | — | — | S13940 | 0.75 | 65 |
| Liquid Composition 31 | MWCNT | 1 | — | — | S13940 | 0.75 | 65 |
| Liquid Composition 32 | MWCNT | 1 | — | — | S13940 | 0.75 | 65 |
| Liquid Composition 33 | MWCNT | 1 | — | — | S13940 | 0.75 | 65 |
| Liquid Composition 34 | MWCNT | 1 | — | — | S13940 | 0.75 | 65 |
| Liquid Composition 35 | MWCNT | 1 | — | — | S13940 | 0.75 | 65 |
| Liquid Composition 36 | MWCNT | 1 | — | — | S13940 | 0.75 | 65 |
| Liquid Composition 37 | MWCNT | 1 | — | — | S13940 | 0.75 | 65 |
| Liquid Composition 38 | MWCNT | 1 | — | — | S13940 | 0.75 | 65 |

TABLE 5

| | | Physical | | Composition | | | | |
|---|---|---|---|---|---|---|---|---|
| | | properties | | | | Dispersion | Other components | |
| Liquid | | Viscosity | Viscosity | Active material | | medium | Binder | |
| Composition No. | Electrode | η0.1 | η1000 | Material | Wt ratio | Material | Material | Wt ratio |
| Liquid | Positive | 12000 | 100 | NCM1 | 100 | Methyl | P(BMA- | 1.5 |
| Compositon 39 | electrode | | | | | octanoate | DEAmEMA) | |
| Liquid | Positive | 20000 | 120 | NCM1 | 100 | Methyl | PBMA | 2 |
| Composition 40 | electrode | | | | | butyrate | | |
| Liquid | Positive | 20000 | 120 | NCM1 | 100 | Methyl | PBMA | 2 |
| Composition 41 | electrode | | | | | hexanoate | | |
| Liquid | Positive | 20000 | 120 | NCM1 | 100 | Methyl | PBMA | 2 |
| Composition 42 | electrode | | | | | heptanoate | | |
| Liquid | Positive | 20000 | 120 | NCM1 | 100 | Methyl | PBMA | 2 |
| Composition 43 | electrode | | | | | octanoate | | |
| Liquid | Positive | 20000 | 120 | NCM1 | 100 | Methyl | PDEAmEMA | 2 |
| Composition 44 | electrode | | | | | hexanoate | | |
| Liquid | Positive | 20000 | 120 | NCM1 | 100 | Methyl | PDEAmEMA | 2 |
| Composition 45 | electrode | | | | | heptanoate | | |
| Liquid | Positive | 20000 | 120 | NCM1 | 100 | Methyl | PDEAmEMA | 2 |
| Composition 46 | electrode | | | | | octanoate | | |
| Liquid | Positive | 20000 | 120 | NCM1 | 100 | Methyl | P(THFMA- | 2 |
| Composition 47 | electrode | | | | | hexanoate | DEAmEMA) | |
| Liquid | Positive | 20000 | 120 | NCM1 | 100 | Ethyl | P(THFMA- | 2 |
| Composition 48 | electrode | | | | | hexanoate | DEAmEMA) | |

| | Composition | | | | | | |
|---|---|---|---|---|---|---|---|
| | Other components | | | | | | |
| | Conductive auxiliary | | Solid electrolyte | | Dispersant | | |
| Liquid | | Wt | | Wt | | Wt | Solid content |
| Composition No. | Material | ratio | Material | ratio | Material | ratio | [wt %] |
| Liquid Compositon 39 | MWCNT | 1 | — | — | S13940 | 0.75 | 65 |
| Liquid Composition 40 | MWCNT | 0.8 | LPSC | 20 | T9100 | 0.4 | 62 |
| Liquid Composition 41 | MWCNT | 0.8 | LPSC | 20 | T9100 | 0.4 | 61 |
| Liquid Composition 42 | MWCNT | 0.8 | LPSC | 20 | T9100 | 0.4 | 58 |
| Liquid Composition 43 | MWCNT | 0.8 | LPSC | 20 | T9100 | 0.4 | 56 |
| Liquid Composition 44 | AB | 2 | LPSC | 20 | T9100 | 0.4 | 75 |
| Liquid Composition 45 | AB | 2 | LPSC | 20 | T9100 | 0.4 | 73 |
| Liquid Composition 46 | AB | 2 | LPSC | 20 | T9100 | 0.4 | 73 |
| Liquid Composition 47 | AB | 2 | LPSC | 20 | T9100 | 0.4 | 75 |
| Liquid Composition 48 | AB | 2 | LPSC | 20 | T9100 | 0.4 | 73 |

TABLE 6

| | | Physical | | Composition | | | | |
|---|---|---|---|---|---|---|---|---|
| Liquid | | properties | | | | Dispersion | Other components | |
| Composition | | Viscosity | Viscosity | Active material | | medium | Binder | |
| No. | Electrode | η0.1 | η1000 | Material | Wt ratio | Material | Material | Wt ratio |
| Liquid | Positive | 20000 | 120 | NCM1 | 100 | Methyl | P(THFMA- | 2 |
| Composition 49 | electrode | | | | | heptanoate | DEAmEMA) | |
| Liquid | Positive | 20000 | 120 | NCM1 | 100 | Ethyl | P(THFMA- | 2 |
| Composition 50 | electrode | | | | | heptanoate | DEAmEMA) | |
| Liquid | Positive | 20000 | 120 | NCM1 | 100 | Methyl | P(THFMA- | 2 |
| Composition 51 | electrode | | | | | octanoate | DEAmEMA) | |
| Liquid | Positive | 20000 | 120 | NCM1 | 100 | Methyl | P(BMA- | 2 |
| Composition 52 | electrode | | | | | hexanoate | DEAmEMA) | |
| Liquid | Positive | 20000 | 120 | NCM1 | 100 | Methyl | P(BMA- | 2 |
| Composition 53 | electrode | | | | | heptanoate | DEAmEMA) | |
| Liquid | Positive | 20000 | 120 | NCM1 | 100 | Methyl | P(BMA- | 2 |
| Composition 54 | electrode | | | | | octanoate | DEAmEMA) | |
| Liquid | Positive | 20000 | 120 | NCM1 | 100 | Butyl | P(THFMA- | 2 |
| Composition 55 | electrode | | | | | butyrate | DEAmEMA) | |
| Liquid | Positive | 20000 | 120 | NCM1 | 100 | Butyl | P(THFMA- | 2 |
| Composition 56 | electrode | | | | | butyrate | DEAmEMA) | |
| Liquid | Positive | 20000 | 120 | NCM1 | 100 | Butyl | P(THFMA- | 2 |
| Composition 57 | electrode | | | | | butyrate | DEAmEMA) | |

| | Composition | | | | | | |
|---|---|---|---|---|---|---|---|
| | Other components | | | | | | |
| Liquid | Conductive auxiliary | | Solid electrolyte | | Dispersant | | |
| Composition | | Wt | | Wt | | Wt | Solid content |
| No. | Material | ratio | Material | ratio | Material | ratio | [wt %] |
| Liquid Composition 49 | AB | 2 | LPSC | 20 | T9100 | 0.4 | 73 |
| Liquid Composition 50 | AB | 2 | LPSG | 20 | T9100 | 0.4 | 72 |
| Liquid Composition 51 | AB | 2 | LPSC | 20 | T9100 | 0.4 | 70 |
| Liquid Composition 52 | AB:MWCNT | 1.0:0.5 | LPSC | 20 | T9100 | 0.4 | 66 |
| Liquid Composition 53 | AB:MWCNT | 1.0:0.5 | LPSC | 20 | T9100 | 0.4 | 64 |
| Liquid Composition 54 | AB:MWCNT | 1.0:0.5 | LPSG | 20 | T9100 | 0.4 | 62 |
| Liquid Composition 55 | AB | 2 | LPSC | 20 | T9100 | 0.4 | 70 |
| Liquid Composition 56 | AB | 2 | LPSC | 20 | S3000 | 0.4 | 70 |
| Liquid Composition 57 | AB | 2 | LPSC | 20 | SC0708A | 0.4 | 70 |

The details of the materials in Table 1 are as follows.

### —Active Material—

NCM1: lithium nickel cobalt manganate (average primary particle diameter: 3.5 μm, manufactured by TOYOSHIMA Manufacturing Co., Ltd.)
NCM2: lithium nickel cobalt manganate (average primary particle diameter: 10 μm, manufactured by TOYOSHIMA Manufacturing Co., Ltd.)
NCA: lithium nickel cobalt aluminum oxide (average primary particle diameter: 4.0 μm, manufactured by TOYOSHIMA Manufacturing Co., Ltd.)
SiO: silicon oxide (average particle diameter: 1 μm, manufactured by Sigma-Aldrich Co. LLC.)

### —Dispersion Medium—

All organic solvents in Tables 1 to 6 are organic solvents manufactured by Tokyo Chemical Industry Co., Ltd . . .

—Other materials—

### ——Conductive Auxiliary Agent——

AB: acetylene black (manufactured by Denka Company Limited)
MWCNT: single-wall carbon tube (manufactured by Nanocyl SA.)

### ——Binder——

PVdF: polyvinylidene fluoride (manufactured by DAIKIN INDUSTRIES, LTD.)
PMMA: polymethyl methacrylate (molecular weight: 200,000, manufactured by Sigma-Aldrich Co. LLC.)
PBMA: polybutyl methacrylate (molecular weight: 200,000, manufactured by Sigma-Aldrich Co. LLC.)
PDEAmEMA: poly(doethylaminoethyl methacrylate) (molecular weight: 200,000) P(THFMA-DEAmEMA): poly(tetrahydrofurfuryl methacrylate-diethylaminoethyl
methacrylate) copolymer (molecular weight: 250,000, BMA: DEAmEMA=20:80 (mol/mol))
P(BMA-DEAmEMA): poly(butyl methacrylate-diethylaminoethyl methacrylate) copolymer (molecular weight: 150,000, BMA: DEAmEMA=80:20 (mol/mol))

### ——Dispersant——

CMCNa: carboxy methyl cellulose (manufactured by DSK Co., Ltd.)
SC0708A: manufactured by NOF CORPORATION
S3000: manufactured by Lubrizol
BYK-ET3000: manufactured by BYK Chemie GmbH
S13940: manufactured by Lubrizol
T9100: manufactured by Kawaken Fine Chemicals Co., Ltd.

### <Thixotropy Evaluation of Liquid Composition>

A thixotropy evaluation of the liquid composition was performed by a rheometer (MCR302e, manufactured by Anton Paar GmbH) using a cone plate (CP-50, manufactured by Anton Paar GmbH). Using a micropipet, 0.8 mL of the liquid composition was collected, and dripped onto a sample table of the rheometer. The height of the cone plate was adjusted so that the gap between the cone plate and the sample table was to be 0.098 mm. After wiping off the excess liquid composition that flowed out from the sample table and the cone, the thixotropy evaluation was performed under the following conditions. First, a load was applied to the liquid composition at a shear rate of 0.1 s⁻¹ for 300 seconds (a first step). Secondly, the shear rate was increased to 1,000 s⁻¹, and was maintained at 1,000 s⁻¹ for 50 seconds (a second step). Thirdly, the shear rate was again reduced to 0.1 s⁻¹, and was maintained at 0.1 s⁻¹ for 650 seconds (a third step).

The time immediately after the transition from the second step to the third step was determined as 0 seconds, and the viscosity of the liquid composition after δt seconds (the application time difference in the below-described application step of the liquid composition) from the transition to the third step was defined as η(δt). The viscosity of the liquid composition immediately before the transition from the second step to the third step was determined as the viscosity η₁₀₀₀ of the liquid composition at the shear rate of 1,000 s⁻¹. In addition, the viscosity of the liquid composition that was stabilized at the third step was determined as the viscosity η_{0.1} of the liquid composition at the shear rate of 0.1 s⁻¹. In the case where the viscosity η(δt) of the liquid composition at the application time difference δt could not be measured due to a sampling rate of the device, the value was estimated by spline interpolation based on the values before and after the measuring point.

### <Production of Electrode>

### Production Example 1: Example of Discontinuously Applying Liquid Composition by Scanning Single Nozzle Several Times

A valve nozzle disclosed in Japanese Patent No. 7271956 was attached to an inkjet discharge evaluation device (device name: EV2500, manufactured by Ricoh Company Limited), and the liquid composition was applied onto an aluminum foil (a copper foil in the case where the liquid composition was used for a negative electrode active material layer) serving as the substrate at the transporting speed of 60 m/min and at the discharge frequency of 1 kHz (1,000 times/sec), while adjusting the discharge pressure so that a size of the liquid composition after being dried was to be approximately 50 mm×50 mm and a film thickness of the liquid composition was to be 0.1 mm. The nozzle pattern is schematically illustrated in FIG. 19. After applying the liquid composition 12A in the transporting direction of the substrate once, the substrate was returned from the original position, and then the nozzle was moved by 1 mm in the direction B perpendicular to the transporting direction A. This process was repeated every 10 seconds, thereby applying the liquid composition with the width of 50 mm. During the above application process, the application time difference δt was calculated as 10 seconds (δt=10 sec).

### Production Example 2: Example of Discontinuously Applying Liquid Composition by Single Scanning of Multiple Nozzles (Staggered Pattern)

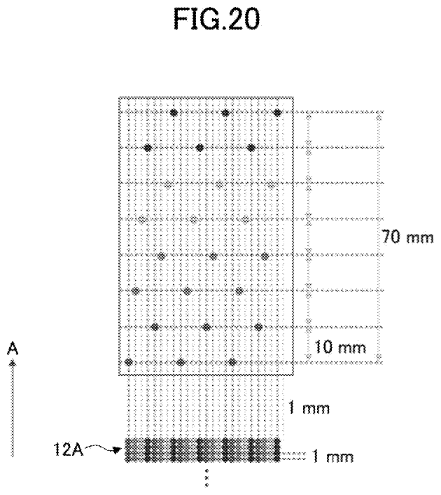

A valve nozzle disclosed in Japanese Patent No. 7271956 was attached to an inkjet discharge evaluation device (device name: EV2500, manufactured by Ricoh Company Limited), and the liquid composition was applied onto an aluminum foil (a copper foil in the case where the liquid composition was used for a negative electrode active material layer) serving as the substrate at the transporting speed of 60 m/min and at the discharge frequency of 1 kHz (1,000 times/sec), while adjusting the discharge pressure so that a size of the liquid composition after being dried was to be approximately 50 mm×50 mm and a film thickness of the liquid composition was to be 0.1 mm. The nozzle pattern is schematically illustrated in FIG. 20. The nozzle had a plurality of discharge holes, and the discharge holes were arranged in the staggered pattern. The liquid composition 12A was discontinuously applied from the plurality of discharge holes, and the application time difference δt was calculated as 0.07 seconds (δt=(70 mm)/(1,000 mm/sec)=0.07 sec).

### Production Example 3: Example of Continuously Applying Liquid Composition by Single Scanning of Multiple Nozzles (Diagonal Arrangement)

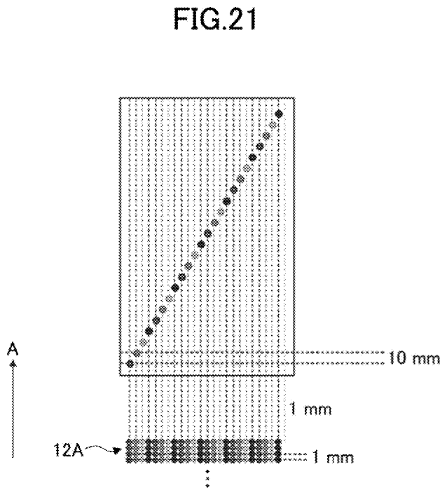

A valve nozzle disclosed in Japanese Patent No. 7271956 was attached to an inkjet discharge evaluation device (device name: EV2500, manufactured by Ricoh Company Limited), and the liquid composition was applied onto an aluminum foil (a copper foil in the case where the liquid composition was used for a negative electrode active material layer) serving as the substrate at the transporting speed of 60 m/min and at the discharge frequency of 1 kHz (1,000 times/sec), while adjusting the discharge pressure so that a size of the liquid composition after being dried was to be approximately 50 mm×50 mm and a film thickness of the liquid composition was to be 0.1 mm. The nozzle pattern is schematically illustrated in FIG. 21. The nozzle had a plurality of discharge holes, and the discharge holes were diagonally arranged. The liquid composition 12A was continuously applied from the plurality of discharge holes, and the application time difference δt was calculated as 0.01 seconds (δt=(10 mm)/(1,000 mm/sec)=0.01 sec).

### Production Example 4: Example of Continuously Applying Liquid Composition by Single Scanning of Multiple Nozzles (Staggered Pattern)

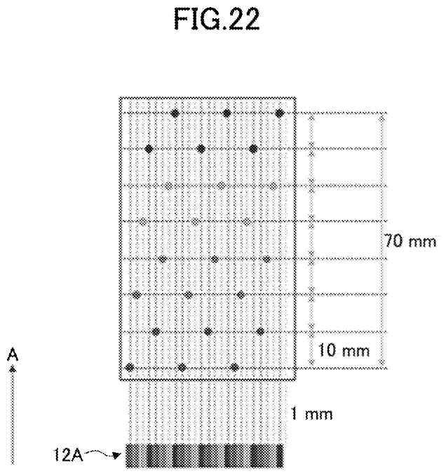

A valve nozzle disclosed in Japanese Patent No. 7271956 was attached to an inkjet discharge evaluation device (device name: EV2500, manufactured by Ricoh Company Limited), and the liquid composition was applied onto an aluminum foil (a copper foil in the case where the liquid composition was used for a negative electrode active material layer) serving as the substrate at the transporting speed of 60 m/min, while adjusting the discharge pressure so that a size of the liquid composition after being dried was to be approximately 50 mm×50 mm and a film thickness of the liquid composition was to be 0.1 mm. The nozzle pattern is schematically illustrated in FIG. 22. The nozzle had a plurality of discharge holes, and the discharge holes were arranged in the staggered pattern. The liquid composition 12A was continuously applied from the plurality of discharge holes, and the application time difference δt was calculated as 0.07 seconds (δt=(70 mm)/(1,000 mm/sec)=0.07 sec).

### Production Example 5

The liquid composition was applied in the same manner as in Production Example 2, except that the transporting speed of the substrate was changed to the speed presented in Table 7.

### <<Production Examples 6 to 8>

The liquid composition was applied in the same manner as in Production Example 1, except that the application time difference δt was changed to the value presented in Table 7 by adjusting the stand-by time of the substrate.

### Production Examples 9 to 13

The liquid composition was applied in the same manner as in Production Example 1, except that the nozzle interval in the direction B perpendicular to the transporting direction A of the substrate was changed to the value presented in Table 7, and the liquid composition was continuously discharged from the discharge holes for each scanning.

### Production Example 14

The liquid composition was applied in the same manner as in Production Example 9, except that the valve inkjet nozzle serving as the liquid discharge device was changed to a jet dispenser (manufactured by MUSASHI ENGINEERING, INC.) and the discharge hole interval was changed.

### Production Example 15

A slit die coater was attached to the inkjet discharge evaluation device, instead of the apparatus for producing the electrode, and the liquid composition was applied onto an aluminum foil serving as the substrate at the transporting speed of 60 m/min, while adjusting a gap and an extrusion amount so that a size of the liquid composition after being dried was to be approximately 50 mm×50 mm and a film thickness of the liquid composition was to be 0.1 mm.

### Production Example 16

The liquid composition was applied in the same manner as in Production Example 1, expect that the liquid composition was applied by spraying.

The details of Production Examples 1 to 16 are summarized in Table 7 below.

### Example 1

Liquid Composition 1 was applied onto the substrate according to Production Example 1. After the application of the liquid composition, the solvent in the liquid composition was evaporated in a drying furnace at 120° C., thereby obtaining an electrode. The uniformity in film thickness of the electrode was evaluated according to the below-described evaluation method for uniformity in film thickness. The result is presented in Table 8.

### Examples 2 to 73 and Comparative Examples 1 to 7

The liquid composition was applied onto the substrate in the same manner as in Example 1, except that the liquid composition and Production Example were changed as described in Tables 8 to 15. After the application of the liquid composition, the solvent in the liquid composition was evaporated in a drying furnace at 120° C., thereby obtaining an electrode. The uniformity in film thickness of the electrode was evaluated according to the below-described evaluation method for uniformity in film thickness. The results are presented in Tables 8 to 15.

### <Evaluation Method for Uniformity in Film Thickness>

A cross-sectional profile of the obtained electrode was acquired by a white light interferometry laser microscope VK-X3000 (manufactured by KEYENCE CORPORATION), and the surface roughness Ra, the ridge height H, and the taper length L were calculated. For cross-sectional profile, both the cross-sectional direction (CMD) perpendicular to the main scanning direction of the substrate with respect to the nozzle and the cross-sectional direction (MD) parallel to the main scanning direction were measured.

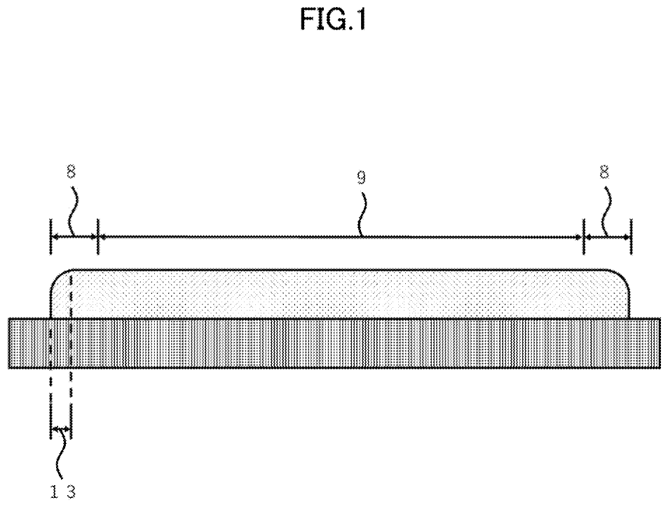

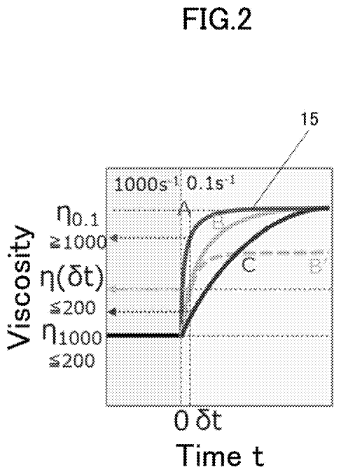

The small surface roughness Ra means excellent in-plane (e.g., 9 in FIG. 1) uniformity in film thickness. Excellent in-plane uniformity in film thickness is expected to bring a uniform current density distribution, and an effect of improving a service life when the electrode is used to produce a battery cell. In view of the degree of influence on the battery life, the surface roughness Ra was evaluated by the following four stages. The evaluation results of 1 to 3 are considered as being acceptable, and the evaluation result of 4 is considered as being unacceptable.

### [Evaluation Criteria]

$$1 : Ra \leq 2 μm$$

$$2 : 2 μm < Ra \leq 4 μm$$

$$3 : 4 μm < Ra \leq 6 μm$$

$$4 : 6 μm < Ra$$

The small ridge height H can avoid a local concentration of the stress at the edges of the active material layer in the pressing step, and can contribute to in-plane uniformity and a high volumetric density of the electrode. Therefore, a high output of a battery cell, and an effect of improving a service life can be expected. In view of the degree of the influence on such effects, the ridge height H was evaluated by the following four stages. The evaluation results of 1 to 3 are considered as being acceptable, and the evaluation result of 4 is considered as being unacceptable.

### [Evaluation Criteria]

$$1 : H \leq 2 μm$$

$$2 : 2 μm < H \leq 5 μm$$

$$3 : 5 μm < H \leq 8 μm$$

$$4 : 8 μm < H$$

When the taper length L (13 in FIG. 1) is short, the electrode area ratio contributing to charging and discharging increases. Therefore, an effect of improving the energy density can be expected. In view of the degree of the influence on such an effect, the taper length L was evaluated by the following four stages. The evaluation results of 1 to 3 are considered as being acceptable, and the evaluation result of 4 is considered as being unacceptable.

### [Evaluation Criteria]

$$1 : L \leq 1 mm$$

$$2 : 1 mm < L \leq 2 mm$$

$$3 : 2 mm < L \leq 3 mm$$

$$4 : 3 mm < L$$

TABLE 7

| | Application method | | | | | |
|---|---|---|---|---|---|---|
| | | | | Discharge hole | | |
| | | | | interval in sub- | | |
| | | | Number of | scanning | | |
| Production | | | discharge | direction | Discharge | Application time |
| Example | General name | Head | holes | (resolution)[mm] | hole pattern | difference δt |
| Pro. Ex. 1 | Ink jetting | Valve nozzle | Single | 1 | — | 10 |
| Pro. Ex. 2 | Ink jetting | Valve nozzle | Multiple | 1 | Staggered | 0.07 |
| Pro. Ex. 3 | Ink jetting | Valve nozzle | Multiple | 1 | Diagonal | 0.01 |
| Pro. Ex. 4 | Ink jetting | Valve nozzle | Multiple | 1 | Staggered | 0.07 |
| Pro. Ex. 5 | Ink jetting | Valve nozzle | Multiple | 1 | Staggered | 4.2 |
| Pro. Ex. 6 | Ink jetting | Valve nozzle | Single | 1 | — | 1 |
| Pro. Ex. 7 | Ink jetting | Valve nozzle | Single | 1 | — | 5 |
| Pro. Ex. 8 | Ink jetting | Valve nozzle | Single | 1 | — | 20 |
| Pro. Ex. 9 | Ink jetting | Valve nozzle | Single | 0.2 | — | 5 |
| Pro. Ex. 10 | Ink jetting | Valve nozzle | Single | 0.5 | — | 5 |
| Pro. Ex. 11 | Ink jetting | Valve nozzle | Single | 0.8 | — | 5 |
| Pro. Ex. 12 | Ink jetting | Valve nozzle | Single | 1.5 | — | 5 |
| Pro. Ex. 13 | Ink jetting | Valve nozzle | Single | 2.5 | — | 5 |

| | | | | | |
|---|---|---|---|---|---|
| Pro. Ex. 14 | Jet dispensing | Single | 1 | — | 5 |
| Pro. Ex. 15 | Slit die coating | Single | 1 | — | |
| Pro. Ex. 16 | Spraying | Single | — | — | — |

| | Application method | | | |
|---|---|---|---|---|
| | Discharge | Transporting | | |
| Production | method from | speed x | | |
| Example | nozzle | [MPM] | Directivity | Discontinuity |
| Pro. Ex. 1 | Discontinuous | 60 | With | With |
| Pro. Ex. 2 | Discontinuous | 60 | With | With |
| Pro. Ex. 3 | Continuous | 60 | With | With |
| Pro. Ex. 4 | Continuous | 60 | With | With |
| Pro. Ex. 5 | Continuous | 1 | With | With |
| Pro. Ex. 6 | Discontinuous | 60 | With | With |
| Pro. Ex. 7 | Discontinuous | 60 | With | With |
| Pro. Ex. 8 | Discontinuous | 60 | With | With |
| Pro. Ex. 9 | Continuous | 60 | With | With |
| Pro. Ex. 10 | Continuous | 60 | With | With |
| Pro. Ex. 11 | Continuous | 60 | With | With |
| Pro. Ex. 12 | Continuous | 60 | With | With |
| Pro. Ex. 13 | Continuous | 60 | With | With |
| Pro. Ex. 14 | Continuous | 60 | With | With |
| Pro. Ex. 15 | Continuous | 60 | With | Without |
| Pro. Ex. 16 | Discontinuous | 60 | Without | With |

TABLE 8

| | | | | | Film thickness uniformity | | | | | |
|---|---|---|---|---|---|---|---|---|---|---|
| | Liquid | Production | Application time | | CMD | | | MD | | |
| Example | Composition | Example | difference δt | η(δt) | Ra | H | L | Ra | H | L |
| Ex. 1 | Liquid Composition 1 | Pro. Ex. 6 | 1 | 30 | 1 | 3 | 3 | 1 | 3 | 3 |
| Ex. 2 | Liquid Composition 1 | Pro. Ex. 7 | 5 | 100 | 2 | 3 | 2 | 2 | 3 | 2 |
| Ex. 3 | Liquid Composition 1 | Pro. Ex. 1 | 10 | 200 | 3 | 3 | 2 | 3 | 3 | 2 |
| Comp. Ex. 1 | Liquid Composition 1 | Pro. Ex. 16 | 20 | 1000 | 4 | 4 | 2 | 4 | 4 | 2 |
| Ex. 4 | Liquid Composition 2 | Pro. Ex. 1 | 10 | 200 | 3 | 3 | 2 | 3 | 3 | 2 |
| Ex. 5 | Liquid Composition 6 | Pro. Ex, 1 | 10 | 300 | 3 | 3 | 2 | 3 | 3 | 2 |
| Ex. 6 | Liquid Composition 7 | Pro. Ex. 1 | 10 | 150 | 2 | 3 | 3 | 2 | 3 | 3 |
| Ex. 7 | Liquid Composition 8 | Pro. Ex. 1 | 10 | 150 | 2 | 3 | 3 | 2 | 3 | 3 |
| Ex. 8 | Liquid Composition 9 | Pro. Ex. 1 | 10 | 150 | 2 | 3 | 3 | 2 | 3 | 3 |
| Ex. 9 | Liquid Composition 10 | Pro. Ex. 1 | 10 | 150 | 2 | 3 | 3 | 2 | 3 | 3 |
| Ex. 10 | Liquid Composition 11 | Pro. Ex. 1 | 10 | 150 | 2 | 3 | 3 | 2 | 3 | 3 |
| Ex. 11 | Liquid Composition 12 | Pro. Ex. 1 | 10 | 150 | 2 | 3 | 3 | 2 | 3 | 3 |

TABLE 9

| | | | | | Film thickness uniformity | | | | | |
|---|---|---|---|---|---|---|---|---|---|---|
| | Liquid | Production | Application time | | CMD | | | MD | | |
| Example | Composition | Example | difference δt | η(δt) | Ra | H | L | Ra | H | L |
| Ex. 12 | Liquid Composition 13 | Pro. Ex. 1 | 10 | 150 | 2 | 3 | 3 | 2 | 3 | 3 |
| Ex. 13 | Liquid Composition 14 | Pro. Ex. 1 | 10 | 150 | 2 | 3 | 3 | 2 | 3 | 3 |
| Ex. 14 | Liquid Composition 15 | Pro. Ex. 1 | 10 | 200 | 3 | 3 | 2 | 3 | 3 | 2 |
| Ex. 15 | Liquid Composition 16 | Pro. Ex. 1 | 10 | 300 | 3 | 3 | 2 | 3 | 3 | 2 |
| Ex. 16 | Liquid Composition 17 | Pro. Ex. 1 | 10 | 150 | 2 | 3 | 3 | 2 | 3 | 3 |
| Ex. 17 | Liquid Composition 18 | Pro. Ex. 1 | 10 | 200 | 3 | 3 | 3 | 3 | 3 | 3 |
| Comp. Ex. 2 | Liquid Composition 3 | Pro. Ex. 1 | 10 | 100 | 4 | 4 | 4 | 4 | 4 | 4 |

TABLE 10

| | | | | | Film thickness uniformity | | | | | |
|---|---|---|---|---|---|---|---|---|---|---|
| | Liquid | Production | Application time | | CMD | | | MD | | |
| Example | Composition | Example | difference δt | η(δt) | Ra | H | L | Ra | H | L |
| Ex. 18 | Liquid Composition 19 | Pro. Ex. 7 | 5 | 100 | 2 | 3 | 3 | 2 | 3 | 3 |
| Ex. 19 | Liquid Composition 19 | Pro. Ex. 1 | 10 | 150 | 2 | 3 | 3 | 2 | 3 | 3 |
| Ex. 20 | Liquid Composition 21 | Pro. Ex. 6 | 1 | 170 | 2 | 3 | 3 | 2 | 3 | 3 |
| Ex. 21 | Liquid Composition 21 | Pro. Ex. 7 | 5 | 300 | 3 | 3 | 2 | 3 | 3 | 2 |
| Ex. 22 | Liquid Composition 23 | Pro. Ex. 6 | 1 | 70 | 2 | 3 | 3 | 2 | 3 | 3 |
| Ex. 23 | Liquid Composition 23 | Pro. Ex. 7 | 5 | 200 | 3 | 3 | 3 | 3 | 3 | 3 |
| Ex. 24 | Liquid Composition 24 | Pro. Ex. 7 | 1 | 70 | 2 | 3 | 3 | 2 | 3 | 3 |
| Comp. Ex. 3 | Liquid Composition 21 | Pro. Ex. 1 | 10 | 800 | 4 | 3 | 2 | 4 | 3 | 2 |
| Comp. Ex. 4 | Liquid Composition 23 | Pro. Ex. 1 | 10 | 1500 | 4 | 3 | 2 | 4 | 3 | 2 |
| Comp. Ex. 5 | Liquid Composition 22 | Pro. Ex. 7 | 1 | 300 | 4 | 3 | 4 | 4 | 3 | 4 |

TABLE 11

| | | | | | Film thickness uniformity | | | | | |
|---|---|---|---|---|---|---|---|---|---|---|
| | Liquid | Production | Application time | | CMD | | | MD | | |
| Example | Composition | Example | difference δt | η(δt) | Ra | H | L | Ra | H | L |
| Ex. 25 | Liquid Composition 23 | Pro. Ex. 2 | 0.07 | 55 | 2 | 1 | 2 | 2 | 1 | 2 |
| Ex. 26 | Liquid Composition 23 | Pro. Ex. 3 | 0.01 | 50 | 2 | 2 | 2 | 1 | 2 | 2 |
| Ex. 27 | Liquid Composition 23 | Pro. Ex. 4 | 0.07 | 50 | 1 | 1 | 2 | 1 | 1 | 2 |
| Ex. 28 | Liquid Composition 23 | Pro. Ex. 5 | 4.2 | 300 | 2 | 2 | 2 | 1 | 1 | 2 |
| Ex. 29 | Liquid Composition 20 | Pro. Ex. 7 | 5 | 150 | 2 | 3 | 3 | 2 | 3 | 3 |
| Ex. 30 | Liquid Composition 20 | Pro. Ex. 9 | 5 | 150 | 2 | 3 | 3 | 2 | 1 | 3 |
| Ex. 31 | Liquid Composition 20 | Pro. Ex. 10 | 5 | 150 | 2 | 1 | 3 | 2 | 1 | 3 |
| Ex. 32 | Liquid Composition 20 | Pro. Ex. 11 | 5 | 150 | 2 | 1 | 3 | 2 | 1 | 3 |
| Ex. 33 | Liquid Composition 20 | Pro. Ex. 12 | 5 | 150 | 2 | 1 | 3 | 2 | 1 | 3 |
| Ex. 34 | Liquid Composition 20 | Pro. Ex. 13 | 5 | 150 | 2 | 2 | 3 | 2 | 1 | 3 |
| Ex. 35 | Liquid Composition 20 | Pro. Ex. 14 | 5 | 150 | 2 | 3 | 3 | 2 | 1 | 3 |
| Comp. Ex. 6 | Liquid Composition 23 | Pro. Ex. 15 | — | — | 2 | 3 | 2 | 2 | 4 | 3 |
| Comp. Ex. 7 | Liquid Composition 23 | Pro. Ex. 16 | — | — | 3 | 2 | 4 | 4 | 4 | 4 |

TABLE 12

| | | | | | Film thickness uniformity | | | | | |
|---|---|---|---|---|---|---|---|---|---|---|
| | Liquid | Production | Application time | | CMD | | | MD | | |
| Example | Composition | Example | difference δt | η(δt) | Ra | H | L | Ra | H | L |
| Ex. 36 | Liquid Composition 19 | Pro. Ex. 4 | 0.07 | 52 | 1 | 1 | 2 | 1 | 1 | 2 |
| Ex. 37 | Liquid Composition 21 | Pro. Ex. 4 | 0.07 | 151 | 2 | 1 | 2 | 1 | 1 | 2 |
| Ex. 38 | Liquid Composition 22 | Pro. Ex. 4 | 0.07 | 257 | 2 | 1 | 2 | 1 | 1 | 2 |
| Ex. 39 | Liquid Composition 23 | Pro. Ex. 4 | 0.07 | 53 | 1 | 1 | 2 | 1 | 1 | 2 |
| Ex. 40 | Liquid Composition 24 | Pro. Ex. 4 | 0.07 | 51 | 1 | 1 | 2 | 1 | 1 | 2 |
| Ex. 41 | Liquid Composition 25 | Pro. Ex. 4 | 0.07 | 104 | 1 | 1 | 2 | 1 | 1 | 2 |
| Ex. 42 | Liquid Composition 26 | Pro. Ex. 4 | 0.07 | 105 | 1 | 1 | 2 | 1 | 1 | 2 |
| Ex. 43 | Liquid Composition 27 | Pro. Ex. 4 | 0.07 | 107 | 1 | 1 | 2 | 1 | 1 | 2 |
| Ex. 44 | Liquid Composition 28 | Pro. Ex. 4 | 0.07 | 103 | 1 | 1 | 2 | 1 | 1 | 2 |
| Ex. 45 | Liquid Composition 29 | Pro. Ex. 4 | 0.07 | 103 | 1 | 1 | 2 | 1 | 1 | 2 |

TABLE 13

| | | | | | Film thickness uniformity | | | | | |
|---|---|---|---|---|---|---|---|---|---|---|
| | Liquid | Production | Application time | | CMD | | | MD | | |
| Example | Composition | Example | difference δt | η(δt) | Ra | H | L | Ra | H | L |
| Ex. 46 | Liquid Composition 30 | Pro. Ex. 4 | 0.07 | 110 | 1 | 1 | 2 | 1 | 1 | 2 |
| Ex. 47 | Liquid Composition 31 | Pro. Ex. 4 | 0.07 | 105 | 1 | 1 | 2 | 1 | 1 | 2 |
| Ex. 48 | Liquid Composition 32 | Pro. Ex. 4 | 0.07 | 109 | 1 | 1 | 2 | 1 | 1 | 2 |
| Ex. 49 | Liquid Composition 33 | Pro. Ex. 4 | 0.07 | 107 | 1 | 1 | 2 | 1 | 1 | 2 |
| Ex. 50 | Liquid Composition 34 | Pro. Ex. 4 | 0.07 | 105 | 1 | 1 | 2 | 1 | 1 | 2 |
| Ex. 51 | Liquid Composition 35 | Pro. Ex. 4 | 0.07 | 101 | 1 | 1 | 2 | 1 | 1 | 2 |
| Ex. 52 | Liquid Composition 36 | Pro. Ex. 4 | 0.07 | 108 | 1 | 1 | 2 | 1 | 1 | 2 |
| Ex. 53 | Liquid Compostion 37 | Pro. Ex. 4 | 0.07 | 106 | 1 | 1 | 2 | 1 | 1 | 2 |
| Ex. 54 | Liquid Composition 38 | Pro. Ex. 4 | 0.07 | 110 | 1 | 1 | 2 | 1 | 1 | 2 |
| Ex. 55 | Liquid Composition 39 | Pro. Ex. 4 | 0.07 | 102 | 1 | 1 | 2 | 1 | 1 | 2 |
| Ex. 56 | Liquid Composition 40 | Pro. Ex. 4 | 0.07 | 130 | 2 | 1 | 2 | 1 | 1 | 2 |

TABLE 14

| | | | | | Film thickness uniformity | | | | | |
|---|---|---|---|---|---|---|---|---|---|---|
| | Liquid | Production | Application time | | CMD | | | MC | | |
| Example | Composition | Example | difference δt | η(δt) | Ra | H | L | Ra | H | L |
| Ex. 57 | Liquid Composition 41 | Pro. Ex. 4 | 0.07 | 128 | 1 | 1 | 2 | 1 | 1 | 2 |
| Ex. 58 | Liquid Composition 42 | Pro. Ex. 4 | 0.07 | 129 | 1 | 1 | 2 | 1 | 1 | 2 |
| Ex. 59 | Liquid Composition 43 | Pro. Ex. 4 | 0.07 | 121 | 1 | 1 | 2 | 1 | 1 | 2 |
| Ex. 60 | Liquid Composition 44 | Pro. Ex. 4 | 0.07 | 121 | 1 | 1 | 2 | 1 | 1 | 2 |
| Ex. 61 | Liquid Composition 45 | Pro. Ex. 4 | 0.07 | 128 | 1 | 1 | 2 | 1 | 1 | 2 |
| Ex. 62 | Liquid Composition 46 | Pro. Ex. 4 | 0.07 | 122 | 1 | 1 | 2 | 1 | 1 | 2 |
| Ex. 63 | Liquid Composition 47 | Pro. Ex. 4 | 0.07 | 122 | 1 | 1 | 2 | 1 | 1 | 2 |
| Ex. 64 | Liquid Composition 48 | Pro. Ex. 4 | 0.07 | 131 | 2 | 1 | 2 | 1 | 1 | 2 |
| Ex. 65 | Liquid Composition 49 | Pro. Ex. 4 | 0.07 | 129 | 1 | 1 | 2 | 1 | 1 | 2 |

TABLE 15

| | | | | | Film thickness uniformity | | | | | |
|---|---|---|---|---|---|---|---|---|---|---|
| | Liquid | Production | Application time | | CMD | | | MD | | |
| Example | Composition | Example | difference δt | η(δt) | Ra | H | L | Ra | H | L |
| Ex. 66 | Liquid Composition 50 | Pro. Ex. 4 | 0.07 | 128 | 1 | 1 | 2 | 1 | 1 | 2 |
| Ex. 67 | Liquid Composition 51 | Pro. Ex. 4 | 0.07 | 128 | 1 | 1 | 2 | 1 | 1 | 2 |
| Ex. 68 | Liquid Composition 52 | Pro. Ex. 4 | 0.07 | 126 | 1 | 1 | 2 | 1 | 1 | 2 |
| Ex. 69 | Liquid Composition 53 | Pro. Ex. 4 | 0.07 | 123 | 1 | 1 | 2 | 1 | 1 | 2 |
| Ex. 70 | Liquid Composition 54 | Pro. Ex. 4 | 0.07 | 132 | 2 | 1 | 2 | 1 | 1 | 2 |
| Ex. 71 | Liquid Composition 55 | Pro. Ex. 4 | 0.07 | 126 | 1 | 1 | 2 | 1 | 1 | 2 |
| Ex. 72 | Liquid Composition 56 | Pro. Ex. 4 | 0.07 | 123 | 1 | 2 | 2 | 1 | 2 | 2 |
| Ex. 73 | Liquid Composition 57 | Pro. Ex. 4 | 0.07 | 127 | 1 | 2 | 2 | 1 | 2 | 2 |

As made clear from Examples 1 to 3, it was found that excellent uniformity in film thickness was obtained in the case where the liquid composition including the active material and the dispersion medium was discontinuously applied onto the substrate from the liquid discharge direction with directivity, the liquid composition was discontinuously applied onto the substrate with a time difference δt in the time when the liquid composition landed on the substrate, the viscosity η₁₀₀₀ of the liquid composition at the shear rate of 1,000 s⁻¹ was 200 mPa·sec or less, the viscosity η_{0.1} of the liquid composition at the shear rate of 0.1 s⁻¹ was 1,000 mPa·sec or greater, and when the load was applied to the liquid composition at the shear rate of 0.1 s⁻¹ for 300 seconds, and then the load was increased to the shear rate of 1,000 s⁻¹ and maintained at the shear rate of 1,000 s⁻¹ for 50 seconds, followed by reducing the shear rate to 0.1 s⁻¹, the viscosity value η(δt) of the liquid composition at δt immediately after reduction of the shear rate to 0.1 s⁻¹ was 300 mPa·sec or less.

As made clear from Comparative Example 1, it was found that when the viscosity η(δt) was higher than 300 mPa·sec, the acceptable results of the surface roughness Ra and the ridge height H were not obtained. The reason for the above results is not clear, but it is assumed that, as described above, the unsatisfactory surface roughness Ra and ridge height H were obtained due to a loss of fluidity in the portion of the liquid composition that had been applied earlier.

As made clear from Examples 4 to 17, the viscosity and thixotropy of the liquid composition could be easily adjusted by changing the type, particle diameter, and blending ratio of the active material. In addition, the viscosity and thixotropy of the liquid composition could be easily adjusted by adding the dispersant as one of other components.

Conversely, as it was clear from Comparative Example 2, the effects of the present disclosure were not obtained when η_{0.1} was less than 1,000 mPa·sec. Although the reason is not clear, it is assumed that, since the fluidity of the liquid composition was maintained after being applied onto the substrate, a taper was less likely to be sharp, a ridge was formed due to the coffee stain phenomenon caused by a convective heat transfer during drying, and as a result, the surface roughness Ra was increased.

It was found from Examples 18 to 24 that the effects of the present disclosure were obtained even when the carbon, the binder, the dispersant, and the like were added to the liquid composition as other components. In addition, when the fibrous carbon nanotubes were added as the carbon-based material serving as the other components, or when the polymer material serving as the binder was added, the added materials were complicatedly entangled in the liquid composition to exhibit strong pseudoplasticity as generally known, but favorable uniformity in film thickness was obtained by setting the application time difference δt such that the η(δt) was to be 300 mPa·sec or less.

It was found from Examples 25 to 35 that, when the liquid composition was continuously applied from the single discharge hole, the uniformity in film thickness was particularly excellent in the MD direction. The above results were due to coalescence of droplets without being leveled after the application of the liquid composition. It was also found that the same effect was obtained in both the inkjet printing and the jet dispensing.

In addition, it was found that the uniformity in film thickness in the CMD direction was particularly improved when the liquid composition was applied to the substrate by scanning the plurality of nozzles once in the main scanning direction, rather than when the liquid composition was applied to the substrate by scanning the single nozzle in the main scanning direction several times while moving the single nozzle in the sub-scanning direction. The above result is assumed to be caused because use of the multiple nozzles could reduce the application time difference δt. From the above result, it is understood that the inkjet printing, in which a plurality of discharge holes are precisely disposed, is particularly preferable. Moreover, it is understood that the application time difference δt is preferably less than 5 seconds.

Further, it was found that, when the multiple nozzles were aligned in the staggered pattern in the direction perpendicular to the transporting direction of the substrate, the uniformity in film thickness in the CMD direction was particularly improved. It is assumed that the uniformity in film thickness was improved because the application time difference was reduced for the whole coating film in the case of the staggered pattern, whereas in the case where the nozzles were diagonally aligned, the application time difference of the liquid composition applied from the adjacent nozzles was reduced, but the application time difference for the whole coating film was increased.

Even in the case where the interval of the application of the liquid composition (discharge hole interval of Table 2) was changed, the effects of the present disclosure were maintained, and uniformity in film thickness was further improved with the shorter application interval. It is assumed that the above result was caused because the time and distance for the droplets of the liquid composition discontinuously applied to be joined together could be shortened.

Conversely, when the liquid composition was applied by the die coater, the surface roughness Ra in the MD direction, the ridge height H, and the taper length L did not satisfy the satisfactory criteria. It is assumed that the above results were caused by viscous fingering instability due to passing the liquid composition with a narrow gap between the substrate and the slit die under the conditions at the fast transporting speed, and stringing due to physical separation of the liquid composition from the discharge hole by lifting or lowering the slit die.

In the case where the liquid composition was applied by spraying using a spray device that was the liquid discharge device without directivity, the surface roughness Ra and the taper length L did not satisfy the favorable criteria. It is assumed that the above results were obtained because the application amount of the liquid composition immediately below the nozzle became large, and the application amount at the edges was small because of no directivity.

It was found from Examples 36 to 73 that the effects of the present disclosure could be obtained when the liquid composition included other components.

For example, embodiments of the present disclosure include the following.
<1> A method for producing an electrode, the method including:
   applying a liquid composition, which includes an active material and a dispersion medium, onto a predetermined region of a substrate and onto a region adjacent to the predetermined region with directivity,
wherein, during the applying, a time difference from a time when the liquid composition is applied onto the predetermined region to a time when the liquid composition is applied onto the region adjacent to the predetermined region is determined as δt,
a viscosity η₁₀₀₀ of the liquid composition at a shear rate of 1,000 s⁻¹ is 200 mPa·sec or less, and a viscosity η_{0.1} of the liquid composition at a shear rate of 0.1 s⁻¹ is 1,000 mPa·sec or greater, and
when a shear force is applied to the liquid composition at a shear rate of 1,000 s⁻¹ for 50 seconds, followed by changing the shear rate to a shear rate of 0.1 s⁻¹, a viscosity of the liquid composition at δt seconds after changing the shear rate to 0.1 s⁻¹ is 300 mPa·sec or less.
<2> The method according to <1>,
wherein δt is 5 seconds or less.
<3> The method according to <1> or <2>,
wherein the applying includes continuously applying the liquid composition onto the substrate.
<4> The method according to <1> or <2>,
wherein the applying includes applying the liquid composition onto the substrate by inkjet printing or dispensing, or by both inkjet printing and dispensing.
<5> An apparatus for producing an electrode, the apparatus including:
   a container in which a liquid composition including an active material and a dispersion medium is accommodated; and
   an applicator configured to apply the liquid composition onto a predetermined region of a substrate and onto a region adjacent to the predetermined region,
wherein, during the applying, a time difference from a time when the liquid composition is applied onto the predetermined region to a time when the liquid composition is applied onto the region adjacent to the predetermined region is determined as δt,
a viscosity η₁₀₀₀ of the liquid composition at a shear rate of 1,000 s⁻¹ is 200 mPa·sec or less, and a viscosity η_{0.1} of the liquid composition at a shear rate of 0.1 s⁻¹ is 1,000 mPa·sec or greater, and
when a shear force is applied to the liquid composition at a shear rate of 1,000 s⁻¹ for 50 seconds, followed by changing the shear rate to a shear rate of 0.1 s⁻¹, a viscosity of the liquid composition at δt seconds after changing the shear rate to 0.1 s⁻¹ is 300 mPa·sec or less.
<6> The apparatus according to <5>,
wherein the applicator includes a plurality of discharge holes.
<7> The apparatus according to <5>,
wherein the applicator is configured to continuously apply the liquid composition.
<8> The apparatus according to <6>,
wherein the plurality of discharge holes are arranged in a staggered pattern.
<9> A liquid composition including:
   an active material; and
   a dispersion medium,
wherein a viscosity η₁₀₀₀ of the liquid composition at a shear rate of 1,000 s⁻¹ is 200 mPa·sec or less, and a viscosity η_{0.1} of the liquid composition at a shear rate of 0.1 s⁻¹ is 1,000 mPa·sec or greater.

What is claimed is:

1. A method for producing an electrode, the method comprising:
applying a liquid composition, which includes an active material and a dispersion medium, onto a predetermined region of a substrate and onto a region adjacent to the predetermined region with directivity,
wherein, during the applying, a time difference from a time when the liquid composition is applied onto the predetermined region to a time when the liquid composition is applied onto the region adjacent to the predetermined region is determined as δt,
a viscosity η₁₀₀₀ of the liquid composition at a shear rate of 1,000 s⁻¹ is 200 mPa·sec or less, and a viscosity η_{0.1} of the liquid composition at a shear rate of 0.1 s⁻¹ is 1,000 mPa·sec or greater, and
when a shear force is applied to the liquid composition at a shear rate of 1,000 s⁻¹ for 50 seconds, followed by changing the shear rate to a shear rate of 0.1 s⁻¹, a viscosity of the liquid composition at δt seconds after changing the shear rate to 0.1 s⁻¹ is 300 mPa·sec or less.

2. The method according to claim 1,
wherein δt is 5 seconds or less.

3. The method according to claim 1,
wherein the applying includes continuously applying the liquid composition onto the substrate.

4. The method according to claim 1,
wherein the applying includes applying the liquid composition onto the substrate by inkjet printing or dispensing, or by both inkjet printing and dispensing.

5. An apparatus for producing an electrode, the apparatus comprising:
a container in which a liquid composition including an active material and a dispersion medium is accommodated; and
an applicator configured to apply the liquid composition onto a predetermined region of a substrate and onto a region adjacent to the predetermined region,
wherein, during the applying, a time difference from a time when the liquid composition is applied onto the predetermined region to a time when the liquid composition is applied onto the region adjacent to the predetermined region is determined as δt,
a viscosity η₁₀₀₀ of the liquid composition at a shear rate of 1,000 s⁻¹ is 200 mPa·sec or less, and a viscosity η_{0.1} of the liquid composition at a shear rate of 0.1 s⁻¹ is 1,000 mPa·sec or greater, and
when a shear force is applied to the liquid composition at a shear rate of 1,000 s⁻¹ for 50 seconds, followed by changing the shear rate to a shear rate of 0.1 s⁻¹, a viscosity of the liquid composition at δt seconds after changing the shear rate to 0.1 s⁻¹ is 300 mPa·sec or less.

6. The apparatus according to claim 5,
wherein the applicator includes a plurality of discharge holes.

7. The apparatus according to claim 5,
wherein the applicator is configured to continuously apply the liquid composition.

8. The apparatus according to claim 6,
wherein the plurality of discharge holes are arranged in a staggered pattern.

9. A liquid composition comprising:
an active material; and
a dispersion medium,
wherein a viscosity η₁₀₀₀ of the liquid composition at a shear rate of 1,000 s⁻¹ is 200 mPa·sec or less, and a viscosity η_{0.1} of the liquid composition at a shear rate of 0.1 s⁻¹ is 1,000 mPa·sec or greater.
